(19) United States
(12) Patent Application Publication
(10) Pub. No.: US 2026/0360258 A1
(43) Pub. Date: Nov. 12, 2026

(54) METHOD FOR DETECTING AND RESPONDING TO UNMANNED AERIAL VEHICLE ACTIVITY WITHIN A MONITORED AIRSPACE

(71) Applicant: Guardian RF Corporation, Wilmington, DE (US)

(72) Inventors: Eli Kerstein, Washington, DC (US); Lucas Raskin, Washington, DC (US); John Andrzejewski, Washington, DC (US)

(21) Appl. No.: 19/670,384

(22) Filed: May 7, 2026

Related U.S. Application Data
(60) Provisional application No. 63/802,216, filed on May 8, 2025.

(51) Int. Cl. G08G 5/23; G06V 20/17

(52) U.S. Cl. CPC G08G 5/23; G06V 20/17

(57) ABSTRACT

One variation of a method includes: receiving a set of signals broadcast within a detection zone of a sensor module; detecting an analog video signal, broadcast by an unmanned aerial vehicle, in the set of signals; extracting a sequence of frames, depicting surfaces within a field of view of the unmanned aerial vehicle, from the analog video signal; selecting a frame from the sequence of frames; serving the frame and a sensor location of the sensor module to a localization model configured to search a virtual map for aerial vehicle locations and aerial vehicle headings predicted to yield frames captured by unmanned aerial vehicles traversing the detection zone; receiving an estimated location and an estimated heading of the unmanned aerial vehicle, predicted to yield the frame, from the localization model; and serving an alert, including the estimated location and the estimated heading of the unmanned aerial vehicle, to a user.

### CROSS-REFERENCE TO RELATED APPLICATIONS

This Application claims the benefit of U.S. Provisional Application No. 63/802,216, filed on May 8, 2025, which is incorporated in its entirety by this reference.

### TECHNICAL FIELD

This invention relates generally to the field of aerial vehicle detection operations and, more specifically, to a new and useful method for detecting and responding to unmanned aerial vehicle activity within a monitored airspace in the field of aerial vehicle detection operations.

### BRIEF DESCRIPTION OF THE FIGURES

FIG. 1 is a flowchart representation of a method;

FIG. 2 is a flowchart representation of one variation of the method;

FIGS. 3A and 3B are flowchart representations of one variation of the method;

FIG. 4 is a flowchart representation of one variation of the method;

FIG. 5 is a flowchart representation of one variation of the method;

FIGS. 6A and 6B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

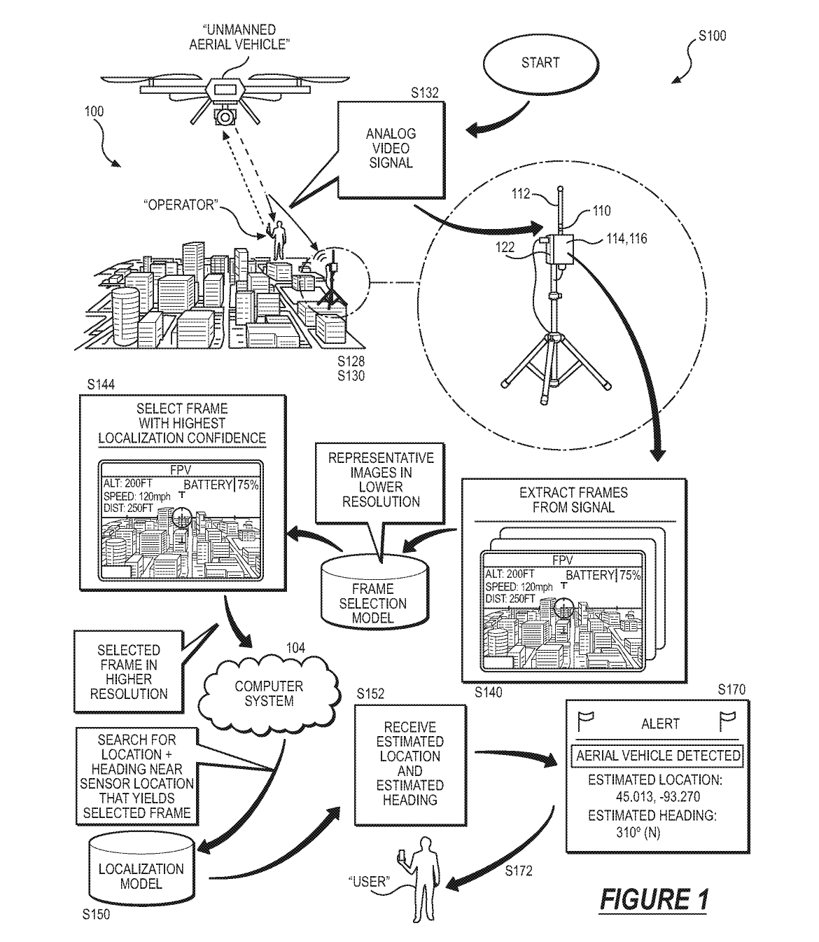

As shown in FIGS. 1, 2, 3A, 3B, 4, 5, 6A, and 6B, a system 100 includes: a sensor module 110; and a remote server. The sensor module 110 includes: a receiver 112; a wireless communication module 114; a controller 116; and a battery 122. The receiver 112 is configured to: receive a set of signals broadcast within a detection zone of the sensor module 110; and detect an analog video signal, broadcast by an unmanned aerial vehicle, in the set of signals. The controller 116 is configured to: extract a sequence of frames, depicting surfaces within a field of view of the unmanned aerial vehicle, from the analog video signal; and serve the sequence of frames to a remote server via the wireless communication module 114. The battery 122 is configured to supply power to the receiver 112 and the controller 116.

The remote server is configured to: access the sequence of frames from the wireless communication module 114; serve a frame, in the sequence of frames, and a sensor location of the sensor module 110 to a localization model configured to search a virtual map for aerial vehicle locations and aerial vehicle headings predicted to yield frames captured by unmanned aerial vehicles traversing the detection zone; receive an estimated location and an estimated heading of the unmanned aerial vehicle, predicted to yield the frame, from the localization model; generate an alert including the estimated location and the estimated heading of the unmanned aerial vehicle; and serve the alert to a user via a user interface.

### 2. Method

As shown in FIGS. 1, 2, 3A, 3B, 4, and 5, a method S100 includes: receiving a set of signals broadcast within a detection zone of a sensor module 110 in Block S130; detecting an analog video signal, broadcast by an unmanned aerial vehicle, in the set of signals in Block S132; extracting a sequence of frames, depicting surfaces within a field of view of the unmanned aerial vehicle, from the analog video signal in Block S140; and selecting a frame, in the sequence of frames, for locating the unmanned aerial vehicle in Block S144.

The method S100 also includes: serving the frame and a sensor location of the sensor module 110 to a localization model configured to search a virtual map for aerial vehicle locations and aerial vehicle headings predicted to yield frames captured by unmanned aerial vehicles traversing the detection zone in Block S150; receiving an estimated location and an estimated heading of the unmanned aerial vehicle, predicted to yield the frame, from the localization model in Block S152; generating an alert including the estimated location and the estimated heading of the unmanned aerial vehicle in Block S170; and serving the alert to a user in Block S172.

### 2.1 Variation: Aerial Vehicle Detection Based on Video Signal Interception

As shown in FIGS. 1, 2, 3A, 3B, 4, and 5, one variation of the method S100 includes: accessing a set of signals broadcast within a detection zone of a sensor module 110 in Block S130; detecting an analog video signal, broadcast by an unmanned aerial vehicle, in the set of signals in Block S132; extracting a sequence of frames, depicting surfaces within a field of view of the unmanned aerial vehicle, from the analog video signal in Block S140; selecting a frame from the sequence of frames in Block S144; deriving an estimated heading of the unmanned aerial vehicle, predicted to yield the frame, based on correspondence between a set of topographical features depicted in the frame and a population of topographical features represented in a virtual map of the detection zone in Block S152; generating an alert including the estimated heading of the unmanned aerial vehicle in Block S170; and serving the alert to a user in Block S172.

### 2.2 Variation: Remote ID Signal Interception + Authorized Aerial Vehicle

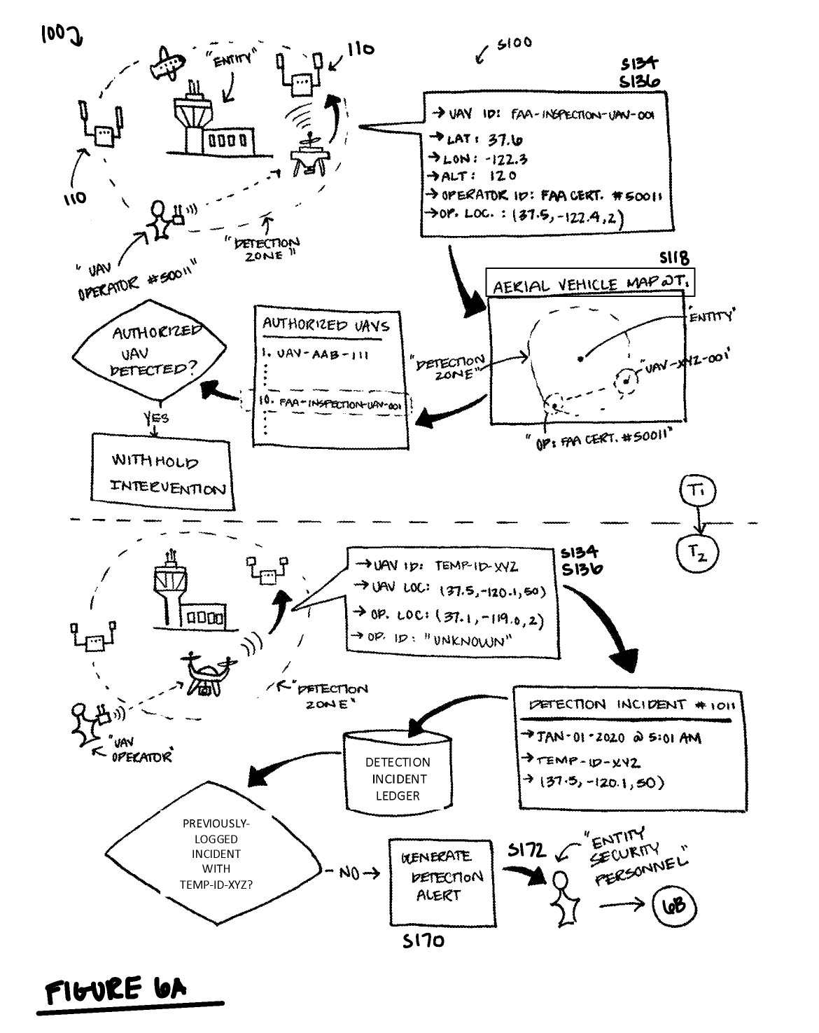

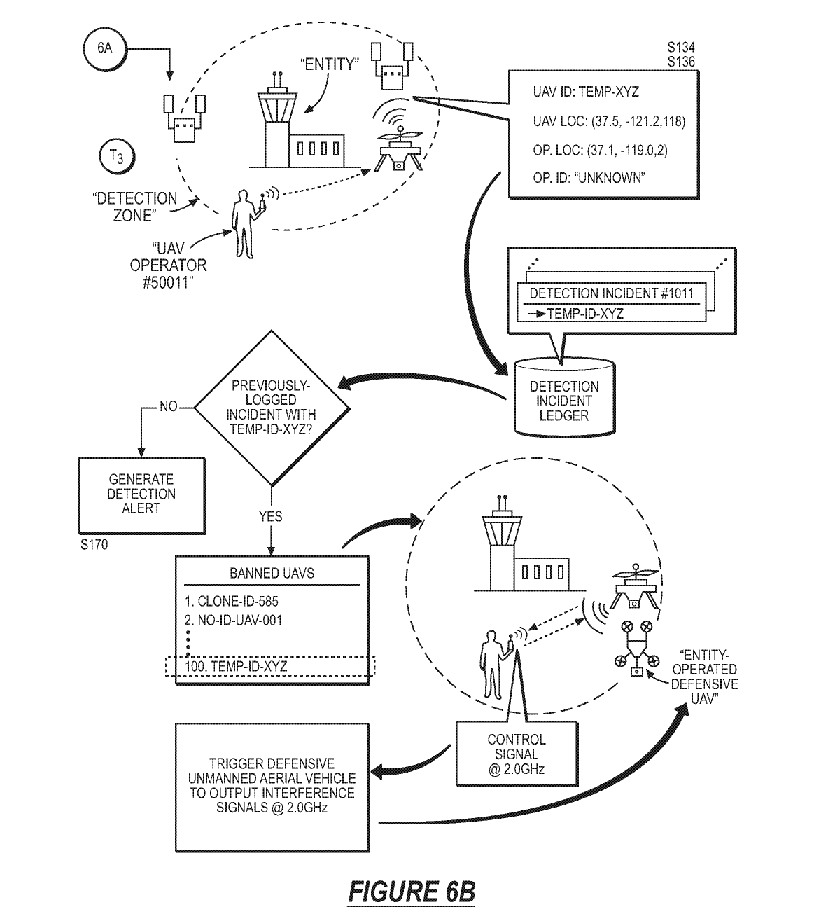

As shown in FIGS. 6A and 6B, one variation of the method S100 includes, during a first time period: intercepting a first set of signals transmitted over a frequency band and within a detection zone associated with an entity in Block S130; and isolating a first identification signal, in the first set of signals, broadcast by a first unmanned aerial vehicle operating within the detection zone in Block S134. This variation of the method S100 further includes extracting a first data package associated with the first unmanned aerial vehicle from the first identification signal in Block S136, the first data package including: a first aerial vehicle identifier; a first aerial vehicle location; and a first operator location of a first operator of the first unmanned aerial vehicle.

This variation of the method S100 also includes: accessing an aerial vehicle map depicting aerial vehicles operating within the detection zone; injecting a first point into the aerial vehicle map representing the first unmanned aerial vehicle proximal the first aerial vehicle location and annotated with the first aerial vehicle identifier in Block S118; and injecting a second point into the aerial vehicle map representing the first operator of the first unmanned aerial vehicle proximal the first operator location in Block S118.

This variation of the method S100 further includes: accessing a list of authorized aerial vehicles associated with aerial vehicles authorized for operation within the detection zone; and, in response to presence of the first aerial vehicle identifier on the list of authorized aerial vehicles, withholding transmission of a first alert indicating presence of the first unmanned aerial vehicle within the detection zone during the first time period.

### 2.3 Variation: Detection Ledger + Automatic Alerts

As shown in FIGS. 6A and 6B, one variation of the method S100 also includes, during a second time period: intercepting a second set of signals transmitted over the frequency band and within the detection zone in Block S130; and isolating a second identification signal, in the second set of signals, broadcast by a second unmanned aerial vehicle operating within the detection zone in Block S134. This variation of the method S100 further includes, during the second time period, extracting a second data package associated with the second unmanned aerial vehicle from the second identification signal in Block S136, the second data package including: a second aerial vehicle identifier; a second aerial vehicle location; and a second operator location of a second operator of the second unmanned aerial vehicle.

This variation of the method S100 also includes: generating a detection entry associated with the second unmanned aerial vehicle and including the second data package; and storing the detection entry in a detection ledger representing historical aerial vehicle detection instances within the detection zone. This variation of the method S100 further includes, in response to absence of the second aerial vehicle identifier in the list of authorized aerial vehicles and in response to absence of a historical detection instance associated with the second unmanned aerial vehicle in the detection ledger: generating a second alert indicating presence of the second unmanned aerial vehicle within the detection zone during the second time period; populating the second alert with the second data package in Block S170; and serving the second alert to security personnel associated with the entity in Block S172.

### 2.4 Variation: Autonomous Response Protocol

As shown in FIGS. 6A and 6B, one variation of the method S100 includes, during a third time period succeeding the second time period: intercepting a third set of signals transmitted over the frequency band and within the detection zone in Block S130; and isolating a third signal, in the third set of signals, broadcast by the second unmanned aerial vehicle in Block S134. This variation of the method S100 also includes extracting a third data package associated with the second unmanned aerial vehicle from the third signal in Block S136, the third data package including: the second aerial vehicle identifier; a second aerial vehicle location; and a third operator location of the second operator of the second unmanned aerial vehicle.

This variation of the method S100 further includes, in response to presence of the detection entry associated with the second aerial vehicle identifier in the detection ledger: appending the second aerial vehicle identifier to a list of unauthorized aerial vehicles associated with aerial vehicles banned from operation within the detection zone; triggering a defensive unmanned aerial vehicle to navigate to the third operator location; intercepting a control signal transmitted at a frequency by a remote controller associated with the second unmanned aerial vehicle; and triggering the defensive unmanned aerial vehicle to output interference signals at the frequency to disrupt transmission of control signals to the second unmanned aerial vehicle.

### 3. Applications

Generally, the method S100 can be executed by a computer system 104 (e.g., a computer network, a remote server) in cooperation with a sensor module 110 (or a network of sensor modules 110) installed at an entity (e.g., an airport, a data center, a residential home, a sports stadium): to monitor aerial vehicle activity within a detection zone (e.g., a restricted and/or monitored airspace) surrounding the sensor module 110; to update an aerial vehicle map representing aerial vehicles operating within the detection zone; to record each aerial vehicle detection instance in a detection ledger representing historical detection instances within the detection zone; to classify each aerial vehicle detection instance based on detection history, authorization status, flight behavior, and/or compliance with predefined operational parameters; and to trigger a response protocol to counteract, deter, or neutralize unauthorized aerial vehicle activity within the detection zone.

In particular, the sensor module 110 defines a detection zone surrounding a volume of airspace where aerial vehicle activity is subject to monitoring, authorization, and/or restriction. More specifically, an entity may define a boundary of the detection zone based on regulatory airspace restrictions, operational security requirements, or predefined geofencing constraints. In one example, a sensor network includes a set of sensor modules 110 arranged about a perimeter of an airport and defining an overlapping detection zone spanning the airport and encompassing a restricted airspace of the airport.

The sensor module 110 can intercept and record radio frequency signals – within a frequency band characteristic of radio frequency communications broadcast by unmanned aerial vehicles (e.g., between 10 MHz and 6 GHz) – broadcast by all radio frequency transmitters within range of the sensor module 110, such as including both unmanned aerial vehicles, handheld radios, cellular towers, GPS sensors, wireless routers, etc. The sensor module 110 can then: isolate an identification signal broadcast by an unmanned aerial vehicle operating within the detection zone; and extract or derive aerial vehicle telemetry data (e.g., an estimated location of the unmanned aerial vehicle, an operator location) based on the identification signal. The computer system 104 can then: update the aerial vehicle map to represent the unmanned aerial vehicle, such as to represent the unmanned aerial vehicle proximal a location broadcast by the unmanned aerial vehicle and/or an operator of the unmanned aerial vehicle proximal an operator location; record the detection instance in the detection ledger; and serve an alert to an operator monitoring the airspace that indicates presence of the unmanned aerial vehicle within the detection zone.

Accordingly, the computer system 104 can: represent each unmanned aerial vehicle detected in the detection zone in the aerial vehicle map to visualize real-time aerial vehicle activity within the detection zone; and record each detection instance to maintain a comprehensive record of aerial vehicle activity within the detection zone. The computer system 104 can then: access the aerial vehicle map and/or the detection ledger to detect trends in historical and/or current aerial vehicle activity, such as increased unmanned aerial vehicle activity near sensitive (e.g., high-security) areas; and select a response protocol, such as based on aerial vehicle telemetry data broadcast by the unmanned aerial vehicle or based on these current and historical records.

### 3.1 Analog Video-Based Aerial Vehicle Localization

In one application, the computer system 104 can localize an unmanned aerial vehicle operating within the detection zone based on an analog video signal (e.g., an unencrypted signal) broadcast by the unmanned aerial vehicle, without requiring any cooperative identification signal or telemetry broadcast from the unmanned aerial vehicle. In particular, the computer system 104 can construct a virtual map of the detection zone by: segmenting the detection zone into a set of subzones; and aggregating, for each subzone, a set of images depicting topographical features of surfaces and objects (e.g., buildings, terrain features, bodies of water, and/or foliage) within the subzone from a set of headings and altitudes. In particular, each image depicts surfaces within an oblique perspective replicating the forward-facing, low-altitude viewpoint of an unmanned aerial vehicle traversing the subzone (e.g., rather than the orthogonal overhead perspective of satellite imagery).

The sensor module 110 can then: scan a frequency band characteristic of analog video signals broadcast by unmanned aerial vehicles (e.g., between 5.4 GHz and 5.96 GHz); detect an analog video signal broadcast by an unmanned aerial vehicle operating within the detection zone; and demodulate the analog video signal to extract a sequence of frames (e.g., first person view frames) depicting surfaces within the field of view of the unmanned aerial vehicle. The sensor module 110 can then: select a frame exhibiting distinctive topographical features for localization within the virtual map; and serve this frame to the computer system 104.

The computer system 104 can then serve the selected frame and the sensor location of the sensor module 110 to a localization model configured to register the frame against images of the virtual map to derive an estimated location and an estimated heading of the unmanned aerial vehicle. In particular, the localization model identifies the image in the virtual map exhibiting the highest correspondence to the selected frame and returns the location and heading labeled with that image as the estimated location and estimated heading of the unmanned aerial vehicle.

In one example, in response to receiving an estimated location and an estimated heading of an unmanned aerial vehicle operating near a sports stadium, the computer system 104 can: detect that the estimated heading of the unmanned aerial vehicle is oriented toward a virtual boundary surrounding a virtual representation of the stadium in the virtual map; estimate a time of arrival of the unmanned aerial vehicle at the stadium based on a velocity of the unmanned aerial vehicle; and serve an alert to security personnel indicating the estimated location, estimated heading, and time of arrival of the unmanned aerial vehicle.

Additionally, the computer system 104 can extract overlay features from the on-screen display (OSD) of the selected frame — such as operator coordinates, battery state of charge, velocity, and/or telemetry data — and cross-reference these features against the estimated location and heading derived from the localization model to corroborate or flag inconsistencies in the data broadcast by the unmanned aerial vehicle. The computer system 104 can then derive additional intelligence from the overlay features, such as: identifying the vehicle type of the unmanned aerial vehicle; estimating a payload based on excess power consumption relative to the nominal power consumption of the vehicle type; calculating a risk score based on the vehicle type and the presence or absence of specific overlay feature types; and extrapolating a projected flight zone representing predicted future positions of the unmanned aerial vehicle based on successive estimated locations and headings and the maneuverability characteristics of the vehicle type.

Thus, the computer system 104 can locate, characterize, and predict the flight path of uncooperative unmanned aerial vehicles, such as unmanned aerial vehicles failing to broadcast identification signals. More specifically, the computer system 104 can intercept analog video signals (e.g., unencrypted analog video feed transmitted to the operator of the unmanned aerial vehicle) required for first-person view operation of the unmanned aerial vehicle. The computer system 104 can then predict intent of the unmanned aerial vehicle prior to the unmanned aerial vehicle reaching critical infrastructure, such as based on an estimated trajectory, a projected flight zone, a vehicle type, an estimated payload, and/or a risk score derived from overlay features of the intercepted analog video feed. Therefore, the system 100 can detect, locate, and characterize unmanned aerial vehicles operating within the detection zone — including uncooperative platforms transmitting no identification signals — and generate targeted alerts with lead time for operators to respond prior to the unmanned aerial vehicle reaching critical infrastructure.

### 3.2 Response Protocols

In one application, in response to detecting an unmanned aerial vehicle operating within the detection zone, the computer system 104 can select a response protocol to address presence of the unmanned aerial vehicle. In particular, the computer system 104 can: interpret a risk level associated with the detected aerial vehicle based on prior detection instances, an authorization status of the unmanned aerial vehicle, unauthorized flight patterns, and/or discrepancies between broadcasted and actual locations; and select a response protocol based on this interpreted risk level. In one example, in response to detecting an unmanned aerial vehicle, such as a delivery drone operating near a residential detection zone, the computer system 104 can: access a “whitelist” specifying aerial vehicles authorized (i.e., by the entity) for operation within the detection zone; identify presence of the delivery drone on the whitelist; populate the aerial vehicle map with a point representing the delivery drone; and withhold intervention (i.e., ignore presence of the delivery drone).

In another example, in response to detecting an unmanned aerial vehicle, such as a surveillance drone operating near a restricted area, the computer system 104 can: access a “blacklist” specifying aerial vehicles banned from (i.e., by the entity) operation within the detection zone; identify presence of the surveillance drone on the blacklist; serve an alert, indicating presence of the surveillance drone within the restricted area, to security personnel; and trigger a defensive unmanned aerial vehicle (i.e., affiliated with or operated by the entity) to navigate to the surveillance drone to force the surveillance drone to vacate the detection zone and/or disable the surveillance drone. Thus, the computer system 104 can dynamically assess and respond to unmanned aerial vehicle activity within the detection zone by evaluating risk levels and selecting an appropriate response protocol. By distinguishing between authorized, unauthorized, and potentially malicious aerial vehicles, the system 100 can facilitate secure airspace management and automate defense measures to mitigate unauthorized operations.

### 4. Sensor Module + Sensor Network

As shown in FIG. 1, the sensor module 110 can include: a receiver 112 configured to intercept and record radio frequency signals broadcast by various communication devices (e.g., unmanned aerial vehicles) over a detection band (e.g., between 10 MHz and 6 GHz); a wireless communication module 114; a controller 116 configured to detect presence of aerial vehicles within the detection zone based on these signals and serve signal data (e.g., frames extracted from an analog video signal) to the computer system 104 (e.g., a remote server) via the wireless communication module 114 (e.g., for vehicle identification and alert generation); a battery 122 configured to supply power to the receiver 112 and the controller 116; and a housing (e.g., a weatherproof housing) configured to house the receiver 112, the wireless communication module 114, the controller 116, and the battery 122. In particular, the sensor module 110 can be configured to receive radio frequency signals broadcast within a detection zone of the sensor module 110 (e.g., within a radius of one to three kilometers of the sensor module 110).

The receiver 112 can include a set of (i.e., one or more) directional antennas configured to record a particular signal from different detection angles. For example, the sensor module 110 can: record a first signal, via a first directional antenna, from a first detection angle within a first field of view (e.g., a 90° field of view) of the first directional antenna and at a first receipt time; and record the first signal, via the second directional antenna, from a second detection angle within a second field of view (e.g., a 90° field of view overlapping the first field of view) of the second directional antenna and at a second receipt time. The sensor module 110 can then: synchronize the first receipt time and the second receipt time; and calculate an estimated location of the unmanned aerial vehicle transmitting the first signal based on a difference between the first receipt time and the second receipt time. Thus, the set of directional antennas can cooperate to capture a particular signal from multiple detection angles to triangulate a position of the unmanned aerial vehicle.

In one variation, a sensor network includes a set of (i.e., two or more) sensor modules 110 deployed across a geographic area, each sensor module 110 configured to receive radio frequency signals broadcast within a detection zone of the sensor module 110. In this variation, the set of sensor modules 110 can define an overlapping detection zone surrounding a volume of airspace, such as a volume of airspace where aerial vehicle activity is subject to monitoring, authorization, and/or restriction (e.g., at an airport).

### 5. Virtual Map Construction

Blocks of the method S100 recite: accessing a description of a sensor location of a sensor module 110 in Block S102; defining a detection zone including a three-dimensional zone surrounding the sensor location of the sensor module 110 in Block S104; segmenting the detection zone into a set of subzones; for each subzone in the set of subzones, accessing a set of images depicting topographical features of surfaces within the subzone in Block S106; and aggregating the set of images into the virtual map of the detection zone in Block S120. Generally, in Block S120, the computer system 104 can generate the virtual map, representing topographical features of surfaces and objects (e.g., buildings, terrain features, and/or landmarks) within the detection zone, based on images depicting surfaces within the detection zone from a set of oblique perspectives.

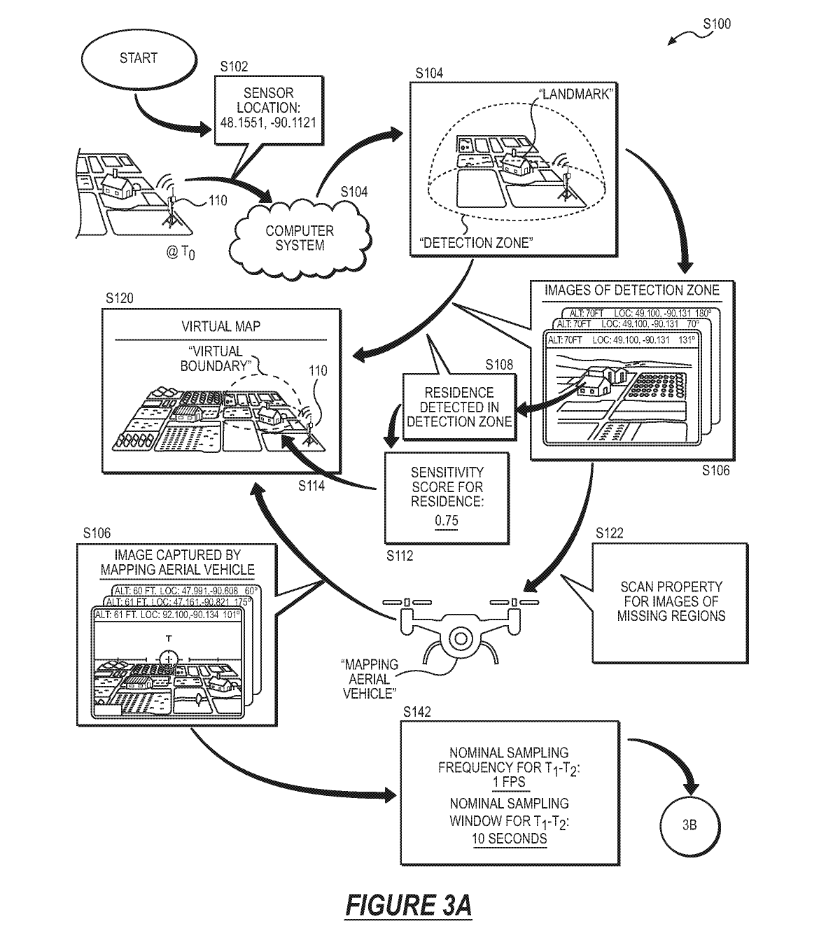

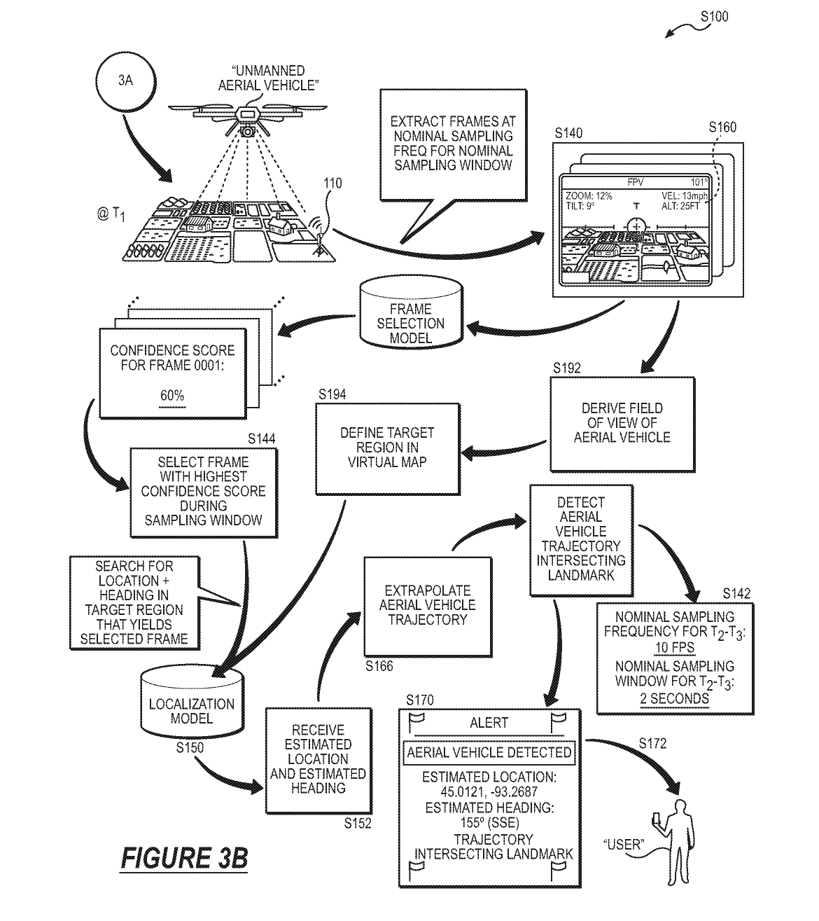

In one implementation, as shown in FIG. 3A, the computer system 104 can: access a description of the sensor location (e.g., a set of coordinates) of the sensor module 110; and define a three-dimensional detection zone surrounding the sensor location of the sensor module 110 (e.g., a spherical or cylindrical volume extending outward from the sensor location to a detection radius of one to three kilometers). In particular, the computer system 104 can define the three-dimensional detection zone including a range of altitudes within which the sensor module 110 can detect signals broadcast by unmanned aerial vehicles such that the virtual map spans the volume of airspace the sensor module 110 monitors.

The computer system 104 can then: segment the three-dimensional detection zone into a set of subzones (e.g., a grid of cells of approximately 50 meters by 50 meters); and, for each subzone in the set of subzones, access a set of images depicting topographical features of surfaces within the subzone, each image labeled with a location, a heading, and an altitude within the subzone. In particular, the computer system 104 can access images depicting topographical features of surfaces within each subzone from a set of headings (e.g., 6 to 12 discrete headings distributed across 360 degrees) and at one or more altitudes such that each subzone includes a set of reference images covering the full range of orientations from which an unmanned aerial vehicle may traverse that subzone. More specifically, these images depict topographical features of surfaces within an oblique perspective corresponding to the field of view of an optical sensor of an unmanned aerial vehicle traversing the subzone (i.e., replicating the forward-facing, low-altitude viewpoint of an aerial vehicle optical sensor). For example, the computer system 104 can access these images from: a set of aerial survey images captured by a mapping aerial vehicle dispatched to scan the detection zone; and/or a set of synthetic images rendered by a flight simulation environment replicating the geographic area of the detection zone at aerial vehicle-level perspectives.

The computer system 104 can then aggregate these images into a virtual map of the detection zone. In particular, the virtual map indexes each image by its labeled location, heading, and altitude within the detection zone, such that the localization model can search the virtual map by registering an intercepted frame against the set of images to identify the location and heading predicted to yield that frame, as described below.

### 5.1 Landmark Detection + Annotation

Blocks of the method S100 recite: detecting a landmark located in the detection zone in Block S108; calculating a sensitivity score for the landmark based on a landmark type in Block S112; and defining a virtual boundary surrounding the landmark in Block S114. Generally, the computer system 104 can: detect landmarks (e.g., power generation facilities, transportation infrastructure, stadiums, and/or government facilities) located in the detection zone based on topographical features depicted in images of the detection zone in Block S112; characterize these landmarks based on landmark type and sensitivity; and annotate these landmarks in the virtual map.

In one implementation, the computer system 104 can implement computer vision techniques — such as object detection, edge detection, and/or template matching — to detect structures and objects (i.e., landmarks) located in the detection zone that exhibit topographical features characteristic of known landmark types. Additionally, the computer system 104 can characterize each detected landmark based on visual and structural features — such as building footprint, rooftop configuration, surrounding infrastructure, and/or proximity to known geographic features — extracted from images depicting the detection zone. For example, the computer system 104 can detect and classify landmarks including: power generation facilities (e.g., nuclear plants, substations, and/or solar farms); transportation infrastructure (e.g., airports, bridges, and/or rail yards); public assembly venues (e.g., stadiums, arenas, and/or convention centers); government and military installations; and/or residential properties.

The computer system 104 can then calculate a sensitivity score for each landmark located in the detection zone based on the landmark type. In particular, the sensitivity score represents the potential impact of an unauthorized drone incursion at the landmark — such that landmark types associated with higher potential for harm, disruption, or strategic compromise receive higher sensitivity scores.

In one implementation, the computer system 104 can define a virtual boundary surrounding a virtual representation of the landmark in the virtual map. In particular, the virtual boundary defines a zone of interest around the landmark within which drone activity triggers heightened monitoring and alert generation — such that the computer system 104 can detect a potential threat prior to the unmanned aerial vehicle physically reaching the landmark. For example, the computer system 104 can define a dimension (e.g., radius, perimeter offset, and/or altitude ceiling) of the virtual boundary proportional to the sensitivity score of the landmark.

Additionally or alternatively, the computer system 104 can: serve the virtual map of the detection zone to a user (e.g., a security operator, a facility manager, and/or a law enforcement officer); and prompt the user to select or annotate landmarks located within the detection zone. Additionally or alternatively, the computer system 104 can: prompt the user to define a virtual boundary surrounding a virtual representation of a landmark by drawing a polygon or perimeter directly on the virtual map; and calculate a sensitivity score for the landmark based on the user-defined virtual boundary and/or a landmark type selected by the user.

Accordingly, by annotating the virtual map with landmarks, sensitivity scores, and virtual boundaries, the computer system 104 can generate targeted alerts and adapt sampling behavior proportionally to the sensitivity of landmarks in the detection zone, thereby prioritizing operator attention toward drone activity that poses the greatest potential threat.

### 5.2 Variation: Aerial Vehicle Scan

In one variation, Block S122 of the method S100 recites dispatching a mapping aerial vehicle to execute a scan of the detection zone. In this variation, the computer system 104 can dispatch a mapping aerial vehicle (e.g., an unmanned aerial vehicle) to capture images of the detection zone from a set of headings and altitudes. In particular, the captured images depict topographical features of surfaces within the detection zone from oblique perspectives replicating the field of view of an unmanned aerial vehicle traversing the detection zone. The computer system 104 can then: access a set of images captured by the mapping aerial vehicle during the scan, each image in the set of images labeled with a heading and an altitude; and implement methods and techniques described above to aggregate the set of images (e.g., in addition to satellite images) into the virtual map of the detection zone.

In one example, the computer system 104 can dispatch the mapping aerial vehicle in response to detecting gaps or insufficient coverage in an existing set of reference images. In this example, the computer system 104 can: access a first set of images (e.g., extant satellite images) depicting topographical features of surfaces within the detection zone; and dispatch the mapping aerial vehicle in response to detecting absence of an image, in the first set of images, depicting a region of the detection zone (e.g., a region containing a landmark) from an oblique perspective. The computer system 104 can then: access a second set of images captured by the mapping aerial vehicle during the scan; and aggregate the first and second sets of images into the virtual map of the detection zone.

Thus, by dispatching a mapping aerial vehicle to capture oblique perspective images of gaps and landmarks in the detection zone, the computer system 104 can supplement existing satellite imagery with ground-level reference images, thereby increasing localization accuracy and heading resolution in regions of the detection zone critical to threat detection.

### 6. Analog Video Signal Interception and Aerial Vehicle Detection

Blocks of the method S100 recite: receiving a set of signals broadcast within a detection zone of a sensor module 110 in Block S130; and detecting an analog video signal, broadcast by an unmanned aerial vehicle, in the set of signals in Block S132. Generally, the sensor module 110 can: receive (e.g., intercept) and record signals (i.e., radio frequency signals) broadcast by various communication devices (e.g., aerial vehicles, Bluetooth devices, Wi-Fi-enabled devices, cellular communication devices) within the detection zone in Block S130; and isolate aerial vehicle signals from the received signals based on signal characteristics of these aerial vehicle signals in Block S132.

In one implementation, the sensor module 110 can: scan a frequency band (e.g., between 5.4 GHz and 5.96 GHz) characteristic of analog video signals broadcast by unmanned aerial vehicles; receive a set of signals broadcast over the frequency band within the detection zone of the sensor module 110; and detect an analog video signal, broadcast by an unmanned aerial vehicle, in the set of signals. In particular, the controller 116 can isolate an analog video signal from the received signals based on signal characteristics (e.g., signal strength, modulation pattern, and/or waveform structure) of the analog video signal within the frequency band. The controller 116 can then demodulate the isolated analog video signal to extract a sequence of frames depicting surfaces within the field of view of the unmanned aerial vehicle.

### 6.1 Aerial Vehicle Detection Based on Remote Identification Signals

Blocks of the method S100 recite: detecting an identification signal broadcast by an unmanned aerial vehicle in Block S134; and extracting a vehicle identifier and a vehicle type of the unmanned aerial vehicle from the identification signal in Block S136. In one implementation, the sensor module 110 can: intercept a set of signals within a frequency band characteristic of radio frequency communications broadcast by unmanned aerial vehicles (e.g., between 10 MHz and 6 GHz); isolate an identification signal (e.g., a Remote Identification (Remote ID) broadcast signal), in the set of signals, broadcast by an unmanned aerial vehicle in Block S134; and extract a data package associated with the unmanned aerial vehicle from the identification signal in Block S136. For example, the sensor module 110 can extract the data package including: an aerial vehicle identifier (e.g., a serial number); a set of aerial vehicle coordinates (e.g., latitude, longitude, altitude); a velocity; a direction of travel (i.e., a trajectory); an operator identifier (e.g., a registered pilot ID, a network-based session identifier); a location of an operator of the unmanned aerial vehicle; a flight origin (e.g., takeoff location); and/or a timestamp of transmission. Accordingly, the sensor module 110 can identify and track unmanned aerial vehicles operating within the detection zone based on intercepted radio frequency communications.

### 6.2 Aerial Vehicle Detection Based on Aerial Vehicle Signatures

In one variation, to detect presence of an unmanned aerial vehicle operating within the detection zone, the sensor module 110 can: intercept a set of signals within a frequency band characteristic of radio frequency communications broadcast by unmanned aerial vehicles; compile amplitudes (or powers, energies) of signals detected during the sampling window into a high-resolution image (e.g., a 1024- by 1024-pixel image), which thus contains representations of all radio frequency transmission signatures of all radio frequency transmitters within range of the sensor module 110, such as including unmanned aerial vehicles, handheld radios, cellular towers, GPS sensors, wireless routers, etc.; and compress the high-resolution image into a low(er)-resolution image (e.g., a 256-pixel spectrogram image). For example, the low(er)-resolution image can represent an analog video signal broadcast by the unmanned aerial vehicle.

In one example, the sensor module 110 can then access a database of template images containing similar low-resolution images: similarly generated from high-resolution images representing intercepted radio frequency signals; and labeled with known unmanned aerial vehicle presence (or absence), distance, and characteristics (e.g., make, model, size, payload, maximum speed). In this example, the sensor module 110 can: implement template-matching techniques to identify a nearest template image, in this database, exhibiting greatest similarity to the new low-resolution image; and extract unmanned aerial vehicle presence (or absence), distance, and/or characteristic labels from this nearest template image. Alternatively, the sensor module 110 can load and implement a model (e.g., a convolutional neural network) configured to ingest a low-resolution image and to return presence (or absence) of an unmanned aerial vehicle, distance, and characteristic information.

### 7. Frame Selection

Blocks of the method S100 recite: extracting a sequence of frames, depicting surfaces within a field of view of an unmanned aerial vehicle, from an analog video signal in Block S140; and selecting a frame, in the sequence of frames, for locating the unmanned aerial vehicle in Block S144. In one implementation, as shown in FIGS. 1 and 3B, upon detecting an analog video signal broadcast by an unmanned aerial vehicle, the controller 116 can demodulate the analog video signal and extract a sequence of frames depicting surfaces within the field of view of the unmanned aerial vehicle. In particular, each frame depicts topographical features of surfaces within an oblique perspective of an optical sensor of the unmanned aerial vehicle such that the frame replicates the forward-facing, low-altitude viewpoint of the optical sensor of the unmanned aerial vehicle. More specifically, the controller 116 can extract each frame from the analog video signal in a first resolution (e.g., 1080p).

In another implementation, upon extracting these frames from the analog video signal, the controller 116 can select a particular frame (or a set of frames) for locating the unmanned aerial vehicle. In this implementation, for each frame in the sequence of frames extracted from the analog video signal, the controller 116 can: convert the frame into a representative image in a second resolution less than the first resolution; serve the representative image to a frame selection model for detection of distinguishable surfaces depicted in the representative image; and receive a confidence score for localization of the frame within the virtual map from the frame selection model.

In particular, the frame selection model can score each representative image based on the presence and variety of distinctive topographical features depicted in the image. For example, a frame depicting a uniform or featureless surface (e.g., open water, dense forest canopy, or flat grassland) may receive a low confidence score, while a frame depicting a variety of distinctive structural and topographical features (e.g., buildings, road intersections, and/or terrain variation) may receive a high confidence score. Thus, the computer system 104 can calculate a confidence score for each frame that reflects the likelihood that the frame contains sufficient visual information for the localization model to identify a corresponding location and heading in the virtual map.

The controller 116 can then select a particular frame for locating the unmanned aerial vehicle based on these confidence scores. For example, the controller 116 can select each frame with a confidence score exceeding a threshold score (e.g., 0.6). Alternatively, the controller 116 can select a single frame with the highest confidence score within a sampling window defined for a particular time period. In particular, in response to expiration of the nominal sampling window, the controller 116 can: select the frame exhibiting the highest confidence score across all frames extracted during the sampling window; and serve this frame to the computer system 104 for localization.

In one implementation, the sensor module 110 can serve a particular frame (or a set of frames) selected for locating the unmanned aerial vehicle to the computer system 104 (e.g., a remote server) via the wireless communication module 114 (e.g., in the first resolution). The computer system 104 can then implement methods and techniques described below to serve the selected frame to a localization model for localization of the unmanned aerial vehicle. Thus, the sensor module 110 can screen extracted frames for localization utility prior to transmission, such as to reduce transmission bandwidth and onboard computational resources without sacrificing location accuracy.

### 7.1 Dynamic Frame Sampling Frequency

In one variation, Blocks of the method S100 recite: defining a nominal sampling frequency and a nominal sampling window for sampling frames during a first time period in Block S142; and, in response to an estimated location of an unmanned aerial vehicle falling within a threshold distance of the landmark, defining a second sampling frequency, greater than the nominal sampling frequency, and a second sampling window, less than the nominal sampling window, for sampling frames during a second time period succeeding the first time period in Block S142.

In this variation, the controller 116 can define a nominal sampling frequency (e.g., 2 frames per second) and a nominal sampling window (e.g., 30 seconds) for sampling (e.g., extracting) frames from a detected analog video signal. The controller 116 can then dynamically adjust the sampling frequency and sampling window in response to changes in the operational context of the detection zone, such as proximity of a detected unmanned aerial vehicle to a landmark or a change in the sensitivity score of the detection zone.

For example, the controller 116 can: define a nominal sampling frequency, proportional to a sensitivity score of the detection zone, and a nominal sampling window, inversely proportional to the sensitivity score, for sampling frames during a first time period; extract a sequence of frames from an analog video signal at the nominal sampling frequency during the nominal sampling window; detect presence of an unmanned aerial vehicle proximal a landmark located within the detection zone (e.g., an estimated location of the unmanned aerial vehicle falling within a threshold distance of the landmark); and, in response to presence of the unmanned aerial vehicle proximal the landmark, define a second sampling frequency, greater than the nominal sampling frequency, and a second sampling window, less than the nominal sampling window, for sampling frames during a second time period succeeding the first time period.

In another example, the controller 116 can adjust the sampling frequency based on confidence scores across frames extracted during the nominal sampling window. In particular, in response to confidence scores across successive frames remaining below a threshold score, the controller 116 can increase the sampling frequency for the subsequent sampling window (i.e., to increase the quantity of candidate frames available for selection). Conversely, in response to confidence scores across successive frames remaining above the threshold score, the controller 116 can decrease the sampling frequency (i.e., to reduce transmission bandwidth).

### 8. Aerial Vehicle Localization

Blocks of the method S100 recite: serving a frame and a sensor location of the sensor module 110 to a localization model configured to search a virtual map for aerial vehicle locations and aerial vehicle headings predicted to yield frames captured by unmanned aerial vehicles traversing the detection zone in Block S150; and receiving an estimated location and an estimated heading of the unmanned aerial vehicle, predicted to yield the frame, from the localization model in Block S152. Generally, in Block S150, the sensor module 110 can serve a particular frame (or a set of frames), in the first resolution (i.e., a higher resolution), selected for locating the unmanned aerial vehicle to the computer system 104 (e.g., a remote server) via the wireless communication module 114. The computer system 104 (e.g., a remote server) can then: access a frame (or a set of frames), selected for localizing the unmanned aerial vehicle, from the wireless communication module 114; serve a frame (or the set of frames) and a sensor location of the sensor module 110 to the localization model; prompt the localization model to localize the frame (or the set of frames) within the virtual map; and receive an estimated location and an estimated heading of the unmanned aerial vehicle, predicted to yield the frame (or the set of frames), from the localization model.

In particular, the localization model can: access the virtual map, including a set of images each depicting topographical features of surfaces within an oblique perspective and corresponding to a candidate location and a candidate heading within the virtual map; search the virtual map for a candidate location and a candidate heading predicted to yield the frame; register the frame against images of the detection zone based on correspondence between topographical features depicted in the frame and topographical features depicted in the images; and return the estimated location and the estimated heading corresponding to a particular image, in the set of images, exhibiting a highest correspondence to the frame.

In one variation, the localization model can return a localization confidence score with the estimated location and estimated heading, the localization confidence score representing correspondence between the frame and the best-matching image in the virtual map. The computer system 104 can then append this localization confidence score to the alert. In another variation, in response to the localization model identifying two or more candidate images corresponding to a frame and returning two or more candidate locations (e.g., different locations separated by a distance exceeding a threshold distance) and/or candidate headings, the computer system 104 can: generate an alert prompting the user to review the candidate locations; populate the alert with the set of candidate locations (and/or candidate headings); and serve the alert to the user.

Thus, the computer system 104 can derive an estimated location and heading of an unmanned aerial vehicle directly from an intercepted analog video frame by registering the frame against a ground-level reference map constructed from the same oblique perspective that the optical sensor of the unmanned aerial vehicle observes, without requiring any cooperative signal or identification broadcast from the unmanned aerial vehicle.

### 9. Automatic Detection Alerts

Blocks of the method S100 recite: generating an alert including the estimated location and the estimated heading of the unmanned aerial vehicle in Block S170; and serving the alert to a user in Block S172. In one implementation, the computer system 104 can automatically serve an alert to an operator that indicates presence of an unmanned aerial vehicle operating within the detection zone in Block S172. In particular, upon detecting presence of an unmanned aerial vehicle operating within the detection zone, the computer system 104 can: generate an alert indicating presence of the unmanned aerial vehicle within the detection zone; populate the alert with the estimated location and the estimated heading of the unmanned aerial vehicle; and serve the alert to an operator (e.g., security personnel, a response team, surveillance personnel, or enforcement personnel) associated with the entity (e.g., via a user interface).

In one variation, the computer system 104 can implement methods and techniques described above to: isolate an identification signal broadcast by an unmanned aerial vehicle operating within the detection zone; and extract a data package (e.g., an aerial vehicle identifier, an aerial vehicle location, and an operator location) from the identification signal. The computer system 104 can then: generate an alert indicating presence of the unmanned aerial vehicle within the detection zone; populate the alert with the data package; and serve the alert to an operator (e.g., security personnel, a response team, surveillance personnel, or enforcement personnel) associated with the entity (e.g., via a user interface).

In another variation, the computer system 104 can generate and serve an alert in response to detecting an unmanned aerial vehicle – exhibiting target characteristics (e.g., an unauthorized flight path, a lack of remote identification, or deviations from expected behavior) – operating within the detection zone.

### 10. Overlay Feature Extraction and Vehicle Type Identification

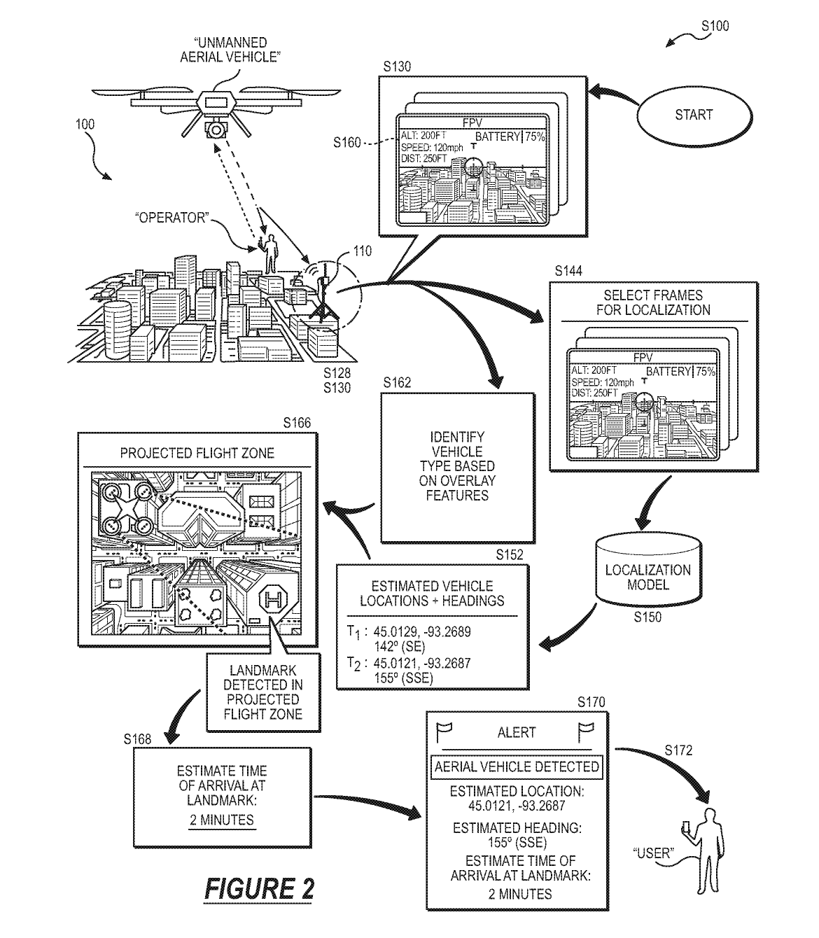

In one variation, as shown in FIGS. 2, 4, and 5, Blocks of the method S100 recite: extracting a set of overlay features from a frame in Block S160; and identifying a vehicle type of the unmanned aerial vehicle based on a distribution of text and iconography of the set of overlay features in Block S162. In this variation, in Block S160, the computer system 104 can extract overlay features — such as operator coordinates, battery state of charge, and/or telemetry data (e.g., velocity, altitude) — from the on-screen display (OSD) of the frame. The computer system 104 can then derive identifying characteristics of the unmanned aerial vehicle — including vehicle type, transmitter model, and operational status — based on these overlay features.

In one example, the computer system 104 can: extract a set of overlay features from a frame; and identify a vehicle type of the unmanned aerial vehicle based on a distribution of text and iconography of the set of overlay features. In particular, the computer system 104 can: detect characteristics (e.g., layout, font, and arrangement) of text and iconography of the set of overlay features; access a vehicle database correlating characteristics of overlay features with known vehicle types; and identify the vehicle type based on correspondence between characteristics of text and iconography in the frame and characteristics of overlay features of a known vehicle type stored in the vehicle database. Thus, the computer system 104 can derive the vehicle type of the unmanned aerial vehicle directly from the analog video feed, without requiring cooperative telemetry or external identification signals from the unmanned aerial vehicle.

### 11. Aerial Vehicle Tracking + Flight Path Extrapolation

In one variation, Blocks of the method S100 recite: extrapolating a projected flight zone representing predicted future positions of the unmanned aerial vehicle in Block S166; and, in response to presence of a virtual representation of a landmark within the projected flight zone, estimating a time of arrival of the unmanned aerial vehicle at the landmark in Block S168. In this variation, the computer system 104 can derive successive estimated locations and headings of the unmanned aerial vehicle across multiple frames and extrapolate a projected flight zone representing predicted future positions of the unmanned aerial vehicle based on these estimated locations and headings.

In one example, the computer system 104 can: serve a first frame, depicting surfaces within the field of view of an unmanned aerial vehicle at a first time to the localization model; receive a first estimated heading and a first estimated location of the unmanned aerial vehicle at the first time from the localization model; serve a second frame, in the sequence of frames, depicting surfaces within the field of view of the unmanned aerial vehicle at a second time, succeeding the first time, to the localization model; and receive a second estimated location and a second estimated heading of the unmanned aerial vehicle at the second time from the localization model. The computer system 104 can then derive an estimated trajectory (and/or a velocity) of the unmanned aerial vehicle based on: the first estimated location; the first estimated heading; the second estimated heading; the second estimated location; the second estimated heading; and a difference between the first time and the second time.

The computer system 104 can then extrapolate a projected flight zone representing predicted future positions of the unmanned aerial vehicle based on the estimated trajectory and the velocity of the unmanned aerial vehicle. In particular, the projected flight zone represents a three-dimensional region of space ahead of the unmanned aerial vehicle — expanding outward from the current position along the estimated trajectory — such that the projected flight zone accounts for uncertainty in future position while bounding the set of reachable positions of the unmanned aerial vehicle within a particular time window.

Additionally or alternatively, the computer system 104 can: identify a vehicle type of the unmanned aerial vehicle based on a distribution of text and iconography of overlay features (e.g., transmitter configuration, font layout, and/or iconography arrangement) present in the frame; access a database correlating vehicle types with maneuverability characteristics (e.g., maximum turn rate, top speed, and/or acceleration limits); and extrapolate the projected flight zone based on the estimated trajectory and a set of maneuverability characteristics of the vehicle type retrieved from the database.

The computer system 104 can then: access the virtual map of the detection zone; and scan the virtual map for presence of virtual representations of landmarks, represented in the virtual map, within the projected flight zone. In response to presence of a virtual representation of a landmark within the projected flight zone, the computer system 104 can estimate a time of arrival of the unmanned aerial vehicle at the landmark based on: the velocity of the unmanned aerial vehicle; and/or a set of maneuverability characteristics of the vehicle type. The computer system 104 can then generate and serve an alert (e.g., to an operator) including: the time of arrival of the unmanned aerial vehicle at the landmark; and a description of the landmark.

In another variation, the computer system 104 can: implement methods and techniques described above to derive an estimated heading and an estimated location of an unmanned aerial vehicle; extrapolate an estimated trajectory of the unmanned aerial vehicle based on the estimated location and the estimated heading; scan the virtual map for intersections between the estimated trajectory of the unmanned aerial vehicle and virtual boundaries surrounding landmarks located in the detection zone; and, in response to the estimated trajectory of the unmanned aerial vehicle intersecting a virtual boundary (e.g., the aerial vehicle oriented toward the virtual boundary), generate an alert including a description of the landmark located along the estimated heading of the unmanned aerial vehicle (and/or a time of arrival to the landmark). Thus, the computer system 104 can detect a potential threat to critical infrastructure and serve an actionable warning to an operator prior to the unmanned aerial vehicle reaching a landmark.

### 11.1 Validation of Reported Telemetry Data

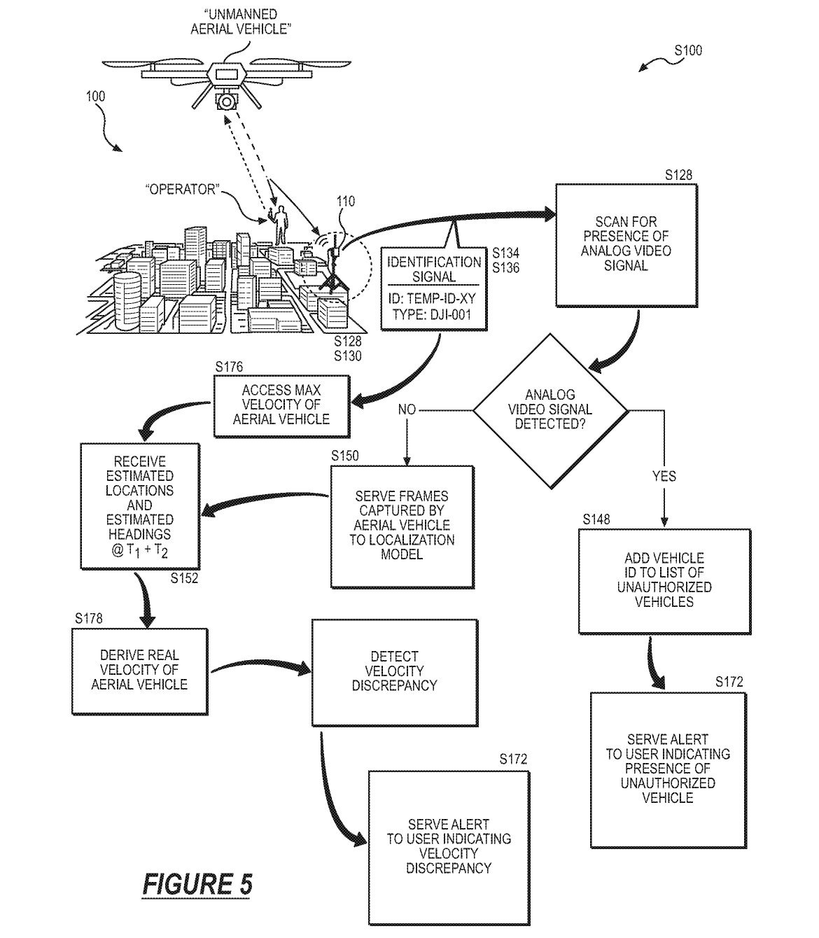

In one variation, as shown in FIG. 5, Blocks of the method S100 recite: extracting a vehicle type of the unmanned aerial vehicle from the identification signal in Block S136; accessing a maximum velocity of the vehicle type in Block S176; and deriving a real velocity of the unmanned aerial vehicle in Block S178. In this variation, the computer system 104 can: receive or intercept an identification signal (e.g., a Remote Identification (Remote ID) broadcast signal) broadcast by an unmanned aerial vehicle; extract a vehicle type (i.e., a self-reported vehicle type) from the identification signal; access a vehicle database correlating vehicle types with known maneuverability characteristics, such as a maximum velocity, maximum altitude, or maximum turning rate; and extract a set of maneuverability characteristics of the vehicle type from the vehicle database.

The computer system 104 can then cross-reference the self-reported vehicle type against observed flight characteristics of the unmanned aerial vehicle to detect inconsistencies indicative of a misrepresented or spoofed vehicle type. In one example, the computer system 104 can: implement methods and techniques described above to derive a first estimated location of the unmanned aerial vehicle at a first time and a second estimated location of the unmanned aerial vehicle at a second time; derive a real velocity of the unmanned aerial vehicle based on the first estimated location and the second estimated location; access a maximum velocity of the vehicle type; and, in response to the real velocity exceeding the maximum velocity of the vehicle type, generate an alert indicating inconsistency between the vehicle type in the identification signal and the real velocity of the unmanned aerial vehicle.

In another variation, the sensor network can implement methods and techniques described above to: isolate a first identification signal broadcast by an unmanned aerial vehicle operating within the detection zone; and extract an aerial vehicle location (i.e., a self-reported location) from the first identification signal. The sensor network can then: record a second signal (e.g., a video downlink signal), via a first sensor module 110, from a first detection angle within a first field of view (e.g., a 90° field of view) of the first sensor module 110 and at a first receipt time; and record the second identification signal, via a second sensor module 110, from a second detection angle within a second field of view (e.g., a 90° field of view overlapping the first field of view) of the second sensor module 110 and at a second receipt time.

The sensor network can then: time-synchronize clocks of the first sensor module 110 and the second sensor module 110 (e.g., based on receipt times of signals broadcast between the sensor modules 110); and calculate (e.g., triangulate, trilaterate) a real aerial vehicle location (e.g., an estimated real location) of the unmanned aerial vehicle based on a first difference between the first receipt time and the second receipt time (e.g., time difference of arrival (TDOA)) and a second difference between the first detection angle and the second detection angle (e.g., angle of arrival (AoA)). In response to detecting a difference between the aerial vehicle location broadcast by the unmanned aerial vehicle and the real aerial vehicle location, the computer system 104 can implement methods and techniques described below to trigger a response protocol, such as issuing an alert to security personnel, triggering a defensive unmanned aerial vehicle to disable the unmanned aerial vehicle, and/or appending the blacklist with the aerial vehicle identifier of the unmanned aerial vehicle.

In another variation, the sensor network can verify that an operator location represented in an identification signal broadcast by an unmanned aerial vehicle corresponds to the real location of the operator. In this variation, the sensor network can implement methods and techniques described above to: calculate (e.g., triangulate) a real operator location (e.g., an estimated real location) of the operator based on an identification signal (e.g., a control signal) received by the sensor modules 110; and trigger a response protocol in response to detecting a difference between the operator location broadcast by the unmanned aerial vehicle and the real operator location.

Accordingly, the sensor network can capture a particular signal from multiple detection angles to calculate real locations of the unmanned aerial vehicle and/or the operator and verify accuracy of the broadcast locations. By verifying accuracy of this broadcast vehicle and/or telemetry data, the sensor network can detect potential malicious intent, such as deliberate location spoofing to evade detection or operate in restricted areas.

### 11.2 Coordinate Verification via Frame-Map Correspondence

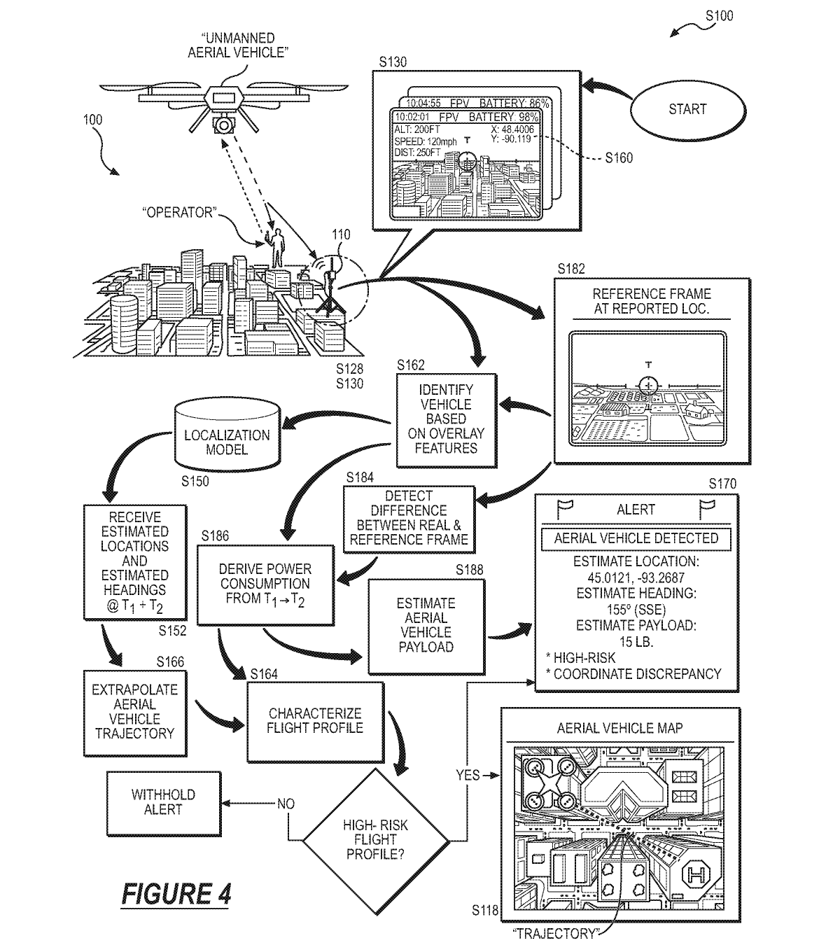

In one variation, as shown in FIG. 4, Blocks of the method S100 recite: extracting a set of coordinates of the unmanned aerial vehicle from a frame in Block S160; retrieving a reference frame representing surfaces predicted to appear within the field of view of the unmanned aerial vehicle at the set of coordinates in Block S182; and detecting a difference between the frame and the reference frame in Block S184.

In one variation, the computer system 104 can verify that an aerial vehicle location represented in a signal broadcast by an unmanned aerial vehicle corresponds to a real location of the unmanned aerial vehicle. In particular, the computer system 104 can detect discrepancies between the broadcast aerial vehicle locations and estimated real locations to identify unmanned aerial vehicles broadcasting inaccurate (or “spoofed”) coordinates. In particular, in this variation, the computer system 104 can cross-reference coordinates indicated in a frame against the virtual map to verify that the surfaces visible in the frame correspond to the surfaces expected at those coordinates.

In this variation, the computer system 104 can: extract a set of coordinates of the unmanned aerial vehicle from a frame (e.g., coordinates broadcast by the unmanned aerial vehicle); and retrieve a reference frame representing surfaces predicted to appear within the field of view of the unmanned aerial vehicle at the set of coordinates. The computer system 104 can then detect a difference between the frame and the reference frame based on differences between: a set of topographical features depicted in the frame; and a set of reference topographical features depicted in the reference frame. For example, the computer system 104 can compare landmarks, terrain features, and/or structural elements visible in the frame against those depicted in the reference frame at the indicated coordinates, such that a frame depicting an urban streetscape while the indicated coordinates correspond to an open field corresponds to a relatively high difference value.

In response to the difference exceeding a threshold difference (e.g., a difference score exceeding 0.5 on a normalized scale, and/or a landmark mismatch rate exceeding 30%), the computer system 104 can generate an alert indicating inconsistency between an estimated location of the unmanned aerial vehicle and the set of coordinates in the frame. Thus, the computer system 104 can detect coordinate “spoofing” by an unmanned aerial vehicle by cross-referencing surfaces depicted in an intercepted frame (e.g., what the vehicle's camera sees) with surfaces predicted to appear at the coordinates indicated in the frame.

### 11.3 Payload Estimation

In one variation, Block S186 of the method S100 recites deriving a power consumption of the unmanned aerial vehicle between a first time and a second time based on: a first state of charge of the unmanned aerial vehicle, depicted in a first frame, at the first time; and a second state of charge of the unmanned aerial vehicle, depicted in a second frame, at the second time succeeding the first time. In this variation, Block S188 of the method S100 also recites estimating a payload of the unmanned aerial vehicle based on: the power consumption; and a nominal power consumption of the vehicle type.

In this variation, the computer system 104 can: extract a first state of charge of the unmanned aerial vehicle at a first time from a first frame; extract a second state of charge of the unmanned aerial vehicle at a second time, succeeding the first time, from a second frame; and derive a power consumption of the unmanned aerial vehicle between the first time and the second time based on the first state of charge and the second state of charge. The computer system 104 can then: implement methods and techniques described above to identify a vehicle type of the unmanned aerial vehicle based on overlay features present in the frames; derive a velocity of the unmanned aerial vehicle based on successive estimated locations of the unmanned aerial vehicle across the first and second frames and/or telemetry data (e.g., airspeed) present in the overlay features of the frames; and access a vehicle database correlating vehicle types with nominal power consumption values (e.g., baseline power draw at a known velocity with no payload attached).

The computer system 104 can then estimate a payload of the unmanned aerial vehicle based on: the power consumption; a nominal power consumption of the vehicle type; and the velocity of the unmanned aerial vehicle. In particular, the computer system 104 can derive an excess power consumption of the unmanned aerial vehicle based on the nominal power consumption of the vehicle type and the measured power consumption such that the excess power consumption represents the additional power draw attributable to carrying a payload beyond the baseline operating load of the vehicle type. The computer system 104 can then estimate a payload weight based on the excess power consumption and the velocity of the unmanned aerial vehicle. The computer system 104 can then populate an alert, indicating presence of the unmanned aerial vehicle, with this payload.

For example, the computer system 104 can: identify a vehicle type corresponding to a mid-size FPV platform with a nominal power consumption of 200 watts at 15 meters per second; derive a measured power consumption of 280 watts between the first time and the second time based on the first and second states of charge; derive an excess power consumption of 80 watts; estimate a payload of approximately 0.4 kilograms based on the excess power consumption and the velocity of the unmanned aerial vehicle; populate an alert with the estimated payload (e.g., flagging the unmanned aerial vehicle as a potential carrier of a dangerous payload); and serve the alert to an operator (e.g., prior to the vehicle reaching critical infrastructure).

### 11.4 Vehicle Risk Score

In one variation, the computer system 104 can extract a set of overlay features from a frame and calculate a risk score for the unmanned aerial vehicle based on the presence or absence of specific feature types in the set of overlay features. In particular, the computer system 104 can extract overlay features — such as operator coordinates, battery state of charge, velocity, altitude, and/or transmitter configuration data — from the OSD of the frame. The computer system 104 can then calculate a risk score for the unmanned aerial vehicle based on the set of overlay features. In particular, the computer system 104 can assign a risk score based on the presence or absence of a set of feature types in the set of overlay features. More specifically, presence or absence of certain overlay features may indicate operational intent and compliance status of the unmanned aerial vehicle. For example, an unmanned aerial vehicle broadcasting full operator coordinates and telemetry data may present a lower risk profile than an unmanned aerial vehicle transmitting a video feed without an operator location visible in the overlay features.

In one example, the computer system 104 can: extract a set of overlay features from a frame depicting an unmanned aerial vehicle transmitting at 5.8 GHz; detect absence of operator coordinate data and absence of transmitter identification in the set of overlay features; calculate a risk score of 0.75 based on these overlay features; and flag the unmanned aerial vehicle for operator review. In particular, the computer system 104 can: populate an alert, indicating presence of the unmanned aerial vehicle, with this risk score; and serve this alert to the operator.

In another variation, the computer system 104 can identify a vehicle type of the unmanned aerial vehicle based on overlay features and incorporate the vehicle type into the risk score calculation. In particular, the computer system 104 can: implement methods and techniques described above to identify a vehicle type of the unmanned aerial vehicle based on overlay features; access a vehicle database correlating vehicle types with baseline risk classifications (e.g., consumer drone, commercial FPV, military-grade FPV); and calculate a risk score for the unmanned aerial vehicle based on the set of overlay features and the vehicle type.

In one example, the computer system 104 can: identify a vehicle type corresponding to a military-grade FPV transmitter configuration based on the distribution of text and iconography in the OSD; detect absence of operator coordinate data in the set of overlay features; calculate a risk score of 0.95 based on absence of operator coordinate data; and automatically generate and serve an alert, including this risk score, to the operator. Thus, in this variation, the computer system 104 can predict the threat level of a detected unmanned aerial vehicle directly from the analog video feed such that operators receive targeted alerts (e.g., rather than notifications for each unmanned aerial vehicle detected in the detection zone).

### 11.5 Camera Intrinsic-Based Search Space Reduction

In one variation, Blocks of the method S100 recite: deriving the field of view of the unmanned aerial vehicle based on a set of optical sensor parameters extracted from the frame in Block S192; and defining a target region of the virtual map by snapping an apex of the field of view to a horizontal plane at an altitude of the unmanned aerial vehicle, extracted from the frame, within the virtual map in Block S194. In this variation, the controller 116 can: extract optical sensor parameters (e.g., zoom level, gimbal tilt, and/or gimbal orientation) and an altitude of the unmanned aerial vehicle from a frame; and derive the field of view of the unmanned aerial vehicle based on the optical sensor parameters.

For example, the computer system 104 can then derive an angular width of the field of view based on the zoom level and an orientation of the field of view based on the gimbal tilt. The computer system 104 can then: access the virtual map of the detection zone; define a horizontal plane within the virtual map at the altitude of the unmanned aerial vehicle; snap an apex of the field of view to the horizontal plane; and define a target region of the virtual map as the area of the virtual map falling within the field of view projected downward from the horizontal plane. The computer system 104 can then serve the frame, the sensor location, and a prompt to search the target region of the virtual map for estimated locations and estimated headings predicted to yield the frame when occupied by the unmanned aerial vehicle. Thus, the computer system 104 can narrow the localization search to a bounded target region of the virtual map derived from the optical sensor parameters and altitude of the unmanned aerial vehicle, thereby reducing candidate locations and headings that the localization model evaluates per frame.

### 12. Detection Ledger

In one variation, the computer system 104 can record each aerial vehicle detection instance in a detection ledger (e.g., maintained by the entity) that represents historical aerial vehicle detection instances within the detection zone. For example, for each aerial vehicle detection instance (or “detection instance”), the computer system 104 can record: an aerial vehicle identifier of the unmanned aerial vehicle; an operator location of the operator associated with the unmanned aerial vehicle; and/or a timestamp of the unmanned aerial vehicle detection instance. In this variation, the computer system 104 can: intercept an identification signal broadcast by an unmanned aerial vehicle operating within the detection zone; extract a data package associated with the unmanned aerial vehicle from the identification signal; generate a detection entry associated with the aerial vehicle and including the set of data; and store the detection entry in the detection ledger.

Thus, the computer system 104 can record each detection instance to maintain a comprehensive record of aerial vehicle activity within the detection zone. The computer system 104 can then implement methods and techniques described below: to identify trends in aerial vehicle activity, such as increased unmanned aerial vehicle activity near sensitive (e.g., high-security) areas; and/or to derive correlations between detection instances, such as repeated incursions by the same aerial vehicle identifier, or multiple unmanned aerial vehicles operating within close proximity.

### 13. Aerial Vehicle Map

In one variation, the computer system 104 can maintain an aerial vehicle map representing each aerial vehicle operating within the detection zone. For example, the computer system 104 can implement methods and techniques described above to: isolate an identification signal broadcast by an unmanned aerial vehicle operating within the detection zone; and extract a data package from the identification signal including an aerial vehicle identifier, an aerial vehicle location, and an operator location of an operator of the unmanned aerial vehicle. The computer system 104 can then: access the aerial vehicle map depicting aerial vehicles operating within the detection zone; inject a first point into the aerial vehicle map representing the unmanned aerial vehicle proximal the aerial vehicle location and annotated with the aerial vehicle identifier and/or a trajectory of the unmanned aerial vehicle; and inject a second point into the aerial vehicle map representing the operator of the unmanned aerial vehicle proximal the operator location. Thus, the computer system 104 can dynamically update the aerial vehicle map to reflect real-time aerial vehicle activity detected within the detection zone.

### 13.1 Flight Profile Characterization and Alert Filtering

In one variation, as shown in FIG. 4, Blocks of the method S100 recite: extrapolating an estimated trajectory of an unmanned aerial vehicle in Block S166; injecting a set of points, representing the estimated trajectory of the unmanned aerial vehicle, into the aerial vehicle map in Block S118; and characterizing a flight profile of the unmanned aerial vehicle based on the estimated trajectory in Block S164. In this variation, the computer system 104 can implement methods and techniques described above to: serve a set of frames, captured by an unmanned aerial vehicle, to the localization model; receive a set of estimated locations and a set of estimated headings of the unmanned aerial vehicle from the localization model; and extrapolate an estimated trajectory of the unmanned aerial vehicle based on the set of estimated locations and the set of estimated headings.

The computer system 104 can then characterize a flight profile of the unmanned aerial vehicle based on the estimated trajectory. In particular, the computer system 104 can classify the estimated trajectory against a set of known flight profile types — such as a straight-line transit, a loitering pattern, a spiral, and/or a direct approach toward a landmark — and assign a flight profile to the unmanned aerial vehicle based on the closest matching profile type. For example, the computer system 104 can detect a repeating circular or spiral pattern in the set of estimated locations and characterize the flight profile as a surveillance pattern, indicating the unmanned aerial vehicle is loitering over a specific area rather than transiting through the detection zone. In another example, the computer system 104 can: estimate a minimum distance between the unmanned aerial vehicle and a landmark located within the detection zone based on the set of estimated locations; and characterize the flight profile of the unmanned aerial vehicle based on the minimum distance and the estimated trajectory.

The computer system 104 can then: inject a set of points into the aerial vehicle map that represent the estimated trajectory of the unmanned aerial vehicle; and annotate these points with a vehicle identifier and/or the flight profile of the unmanned aerial vehicle. Additionally, in response to the flight profile corresponding to a high-risk profile (e.g., direct approach toward a landmark, persistent orientation toward a virtual boundary, and/or loitering proximal a landmark), the computer system 104 can implement methods and techniques described above to generate and serve an alert to the user. Conversely, in response to the flight profile corresponding to a low-risk profile (e.g., straight-line transit, departure from the detection zone, and/or flight path oriented away from landmarks), the computer system 104 can withhold generation of an alert. Thus, the computer system 104 can filter alert generation based on the behavioral intent suggested by the estimated trajectory of the unmanned aerial vehicle.

### 14. Automatic Response Protocols

In one variation, as shown in FIGS. 6A and 6B, upon detecting an unmanned aerial vehicle within the detection zone, the computer system 104 can: interpret a status (e.g., authorized, unauthorized, unknown) of the unmanned aerial vehicle; and trigger a response protocol (e.g., an autonomous or manual response protocol) based on the status, such as logging the detection instance, issuing an alert to security personnel, ignoring detection of an authorized aerial vehicle, or triggering a defensive countermeasure upon detecting an unauthorized unmanned aerial vehicle.

In one variation, in response to detecting an unmanned aerial vehicle within the detection zone, the computer system 104 can: access a list of authorized aerial vehicles (e.g., a “whitelist”) associated with aerial vehicles authorized (i.e., by the entity) for operation within the detection zone; access a list of unauthorized aerial vehicles (e.g., a “blacklist”) associated with aerial vehicles banned from (i.e., by the entity) operation within the detection zone; scan these lists for presence of an aerial vehicle identifier of the unmanned aerial vehicle; and select a response protocol based on presence of the aerial vehicle identifier on the list of authorized aerial vehicles or the list of unauthorized aerial vehicles. In one example, in response to detecting an unauthorized, unmanned aerial vehicle within the detection zone, the computer system 104 can: implement methods and techniques described above to inject a first point into the aerial vehicle map representing the unauthorized, unmanned aerial vehicle and a second point representing the operator of the unmanned aerial vehicle; and flag the first point and/or the second point for review (e.g., by security personnel).

In one variation, in response to detecting an unmanned aerial vehicle within the detection zone, the computer system 104 can: access the detection ledger; scan the detection ledger for presence of historical detection instances associated with the aerial vehicle identifier of the unmanned aerial vehicle; and select a response protocol based on presence or absence of historical detection instances. In one example, in response to detecting an unmanned aerial vehicle within the detection zone, the computer system 104 can implement methods and techniques described above to: extract an aerial vehicle identifier of the unmanned aerial vehicle; scan the list of authorized aerial vehicles for presence of the aerial vehicle identifier; and scan the detection ledger for historical detection instances associated with the unmanned aerial vehicle. In response to presence of the aerial vehicle identifier on the list of authorized aerial vehicles, the computer system 104 can withhold transmission of an alert indicating presence of the unmanned aerial vehicle within the detection zone. Alternatively, in response to absence of the aerial vehicle identifier in the list of authorized aerial vehicles and in response to absence of a historical detection instance associated with the unmanned aerial vehicle in the detection ledger, the computer system 104 can generate and transmit an alert indicating presence of the unmanned aerial vehicle within the detection zone to the operator associated with the entity.

Thus, the computer system 104 can interpret the status of each detected unmanned aerial vehicle within the detection zone to select a response protocol based on authorization status, flight plan compliance, and/or operational context (e.g., proximity to restricted areas, deviation from expected flight paths, detection history, time of detection, or coordination with other aerial vehicles).

### 14.1 Flight Plan Database

In one variation, in response to detecting an unmanned aerial vehicle within the detection zone, the computer system 104 can: access a flight plan database containing published flight plans of aerial vehicles; scan the flight plan database for presence of a flight plan associated with the aerial vehicle identifier of the unmanned aerial vehicle; and select a response protocol based on presence or absence of a flight plan associated with the aerial vehicle identifier. For example, in response to presence of a published flight plan, associated with the aerial vehicle identifier, in the flight plan database, the computer system 104 can append the whitelist with the aerial vehicle identifier of the unmanned aerial vehicle.

### 14.2 Human Intervention Protocols

In one variation, the computer system 104 can dispatch enforcement personnel (e.g., security personnel, local law enforcement) to investigate unauthorized aerial activity within the detection zone. For example, in response to detecting an unmanned aerial vehicle within the detection zone, the computer system 104 can implement methods and techniques described above to: extract an operator location of an operator of the unmanned aerial vehicle; generate an alert indicating presence of the operator proximal the operator location; and serve the alert to enforcement personnel.

In another example, the computer system 104 can implement methods and techniques described above to: annotate the aerial vehicle map with points representing unmanned aerial vehicles (i.e., labeled with aerial vehicle identifiers) operating within the detection zone; identify presence of unauthorized, unmanned aerial vehicles within the detection zone; flag these unauthorized, unmanned aerial vehicles in the aerial vehicle map; and serve this aerial vehicle map to enforcement personnel (e.g., via a native application or web browser executing on a mobile device carried by enforcement personnel). In this example, enforcement personnel may then locate the operator according to the aerial vehicle map to investigate the unauthorized aerial vehicle operation. Thus, the computer system 104 can integrate both unmanned aerial vehicle locations and operator locations within the aerial vehicle map, such that enforcement personnel may rapidly and efficiently investigate unauthorized unmanned aerial vehicle activity and mitigate potential security risks within the detection zone.

### 14.3 Autonomous Aerial Vehicle Disablement

In one variation, the computer system 104 can trigger a defensive unmanned aerial vehicle affiliated with the entity to: navigate to a location proximal an unmanned aerial vehicle; and output interference signals to disrupt communication between the unmanned aerial vehicle and the operator. In particular, the computer system 104 can trigger the defensive unmanned aerial vehicle to output interference signals at the same frequency that control signals (e.g., remote control uplink signals) are transmitted to the unmanned aerial vehicle (i.e., by a remote controller). More specifically, by outputting interference signals at the same frequency as the control signals, the defensive unmanned aerial vehicle can effectively sever communication between the unmanned aerial vehicle and a remote controller transmitting commands (e.g., flight path adjustments, altitude changes, or emergency overrides) to the unmanned aerial vehicle.

In this variation, the computer system 104 can: implement methods and techniques described above to detect an aerial vehicle location of an unmanned aerial vehicle operating within the detection zone; and trigger the defensive unmanned aerial vehicle to navigate to the aerial vehicle location. The sensor module 110 can then intercept a control signal transmitted at a frequency (e.g., 2.4 GHz, 5.8 GHz) by a remote controller associated with the unmanned aerial vehicle. The computer system 104 can then trigger the defensive unmanned aerial vehicle to output interference signals at the frequency to disrupt reception of control signals by the unmanned aerial vehicle.

For example, the sensor module 110 can intercept a first control signal transmitted by a remote controller associated with an unmanned aerial vehicle and characterized by a first signal strength. The computer system 104 can then trigger the defensive unmanned aerial vehicle to navigate in a first direction to intersect a path of the first control signal. The sensor module 110 can then intercept a second control signal transmitted by the remote controller and characterized by a second signal strength. In response to intercepting the second control signal, characterized by the second signal strength less than the first signal strength, the computer system 104 can trigger the defensive unmanned aerial vehicle to navigate in a second direction, different from the first direction, based on the decrease in signal strength. Alternatively, in response to intercepting the second control signal, characterized by the second signal strength greater than the first signal strength, the computer system 104 can trigger the defensive unmanned aerial vehicle to navigate in the first direction (i.e., to maintain the current heading toward the control signal source).

Alternatively, in response to failing to receive control signals from the remote controller, an unmanned aerial vehicle may: execute a forced “Return-to-Home” protocol to return to the flight origin location; or initiate an emergency landing proximal a current location of the unmanned aerial vehicle. Thus, the computer system 104 can trigger the defensive unmanned aerial vehicle to sever the control link and disrupt flight operations by outputting interference signals at the control signal frequency and maintaining proximity to the unmanned aerial vehicle until communication with the remote controller is disrupted, thereby forcing the unmanned aerial vehicle to vacate the detection zone and/or disable the unmanned aerial vehicle.

Additionally or alternatively, in this variation, the computer system 104 can: intercept a video downlink signal (e.g., an analog video signal) transmitted at a frequency (e.g., 2.4 GHz, 5.8 GHz) by the unmanned aerial vehicle; and trigger the defensive unmanned aerial vehicle to output interference signals at the frequency to disrupt transmission of video downlink signals to the remote controller associated with the unmanned aerial vehicle. For example, by disrupting transmission of video downlink signals, the defensive unmanned aerial vehicle can obstruct the operator of the unmanned aerial vehicle from receiving real-time visual feedback, thus impairing manual navigation. Additionally or alternatively, the computer system 104 can trigger the defensive unmanned aerial vehicle to: navigate to a location proximal the operator of the unmanned aerial vehicle; and implement methods and techniques described above to output interference signals to disrupt communication (e.g., control signals and/or video downlink signals) between the unmanned aerial vehicle and the operator.

### 14.4 Aerial Vehicle Blacklist Update

In one variation, Blocks of the method S100 recite: scanning a frequency range, associated with the vehicle type, for presence of analog video signals broadcast by the unmanned aerial vehicle in Block S128; and, in response to absence of an analog video signal broadcast over the frequency range by the unmanned aerial vehicle, populating a list of unauthorized aerial vehicles with the vehicle identifier of the unmanned aerial vehicle in Block S148. In this variation, the computer system 104 can selectively update the list of unauthorized aerial vehicles based on unmanned aerial vehicle activity within the detection zone.

In one example, in response to detecting an unmanned aerial vehicle within the detection zone, the computer system 104 can implement methods and techniques described above to scan the detection ledger for presence of detection instance entries associated with an aerial vehicle identifier of the unmanned aerial vehicle. In response to presence of a detection entry associated with the aerial vehicle identifier, the computer system 104 can append the aerial vehicle identifier to the list of unauthorized aerial vehicles (i.e., banned from operation within the detection zone).

In another example, the computer system 104 can cross-reference an identification signal broadcast by the unmanned aerial vehicle against the frequency range associated with the identified vehicle type to detect absence of a corresponding analog video signal. In particular, in this example, the computer system 104 can: detect a first identification signal broadcast by the unmanned aerial vehicle during a first time period; extract a vehicle identifier and a vehicle type of the unmanned aerial vehicle from the first identification signal; scan a frequency range, associated with the vehicle type, for presence of analog video signals broadcast by the unmanned aerial vehicle; and, in response to absence of a first analog video signal broadcast over the frequency range by the unmanned aerial vehicle, append the aerial vehicle identifier to the list of unauthorized aerial vehicles. In response to intercepting a second identification signal broadcast by the unmanned aerial vehicle during a second time period succeeding the first time period, the computer system 104 can automatically generate an alert in response indicating presence of the vehicle identifier on the list of unauthorized aerial vehicles.

In another example, in response to detecting the unmanned aerial vehicle within the detection zone, the computer system 104 can implement methods and techniques described below to verify accuracy of an aerial vehicle location and/or an operator location broadcast by the unmanned aerial vehicle. In response to detecting a discrepancy between the broadcast locations and the real locations of the unmanned aerial vehicle and/or the operator (i.e., indicating potential malicious activity), the computer system 104 can append the aerial vehicle identifier to the list of unauthorized aerial vehicles. Thus, the computer system 104 can dynamically update the list of unauthorized aerial vehicles based on real-time detection and verification of unmanned aerial vehicle activity.

In another example, in response to detecting the unmanned aerial vehicle within the detection zone, the computer system 104 can implement methods and techniques described above to scan the flight plan database for presence of a flight plan associated with the aerial vehicle identifier. The computer system 104 can then append the aerial vehicle identifier to the list of unauthorized aerial vehicles in response to failing to identify a flight plan associated with the aerial vehicle identifier. By identifying repeated unauthorized entries, detecting unregistered flights, and/or verifying location accuracy, the computer system 104 can prevent unauthorized operations and mitigate potential malicious activity within the detection zone.

### 15. Automatic Sensor Calibration

In one variation, the sensor network can execute a calibration cycle to validate and refine the accuracy of aerial vehicle localization within the detection zone. In this variation, a first sensor module 110 can emulate an aerial vehicle by broadcasting an identification signal representing a synthetic aerial vehicle signature of an unmanned aerial vehicle operating at a first location within the detection zone at a first time. A second sensor module 110 can then implement methods and techniques described above to intercept the identification signal and extract a data packet from the identification signal. The second sensor module 110 can then detect discrepancies between: the first (i.e., known or broadcasted) location; and a measured location estimated by the second sensor module 110 (e.g., derived from time difference of arrival (TDOA) and/or angle of arrival (AoA)). In response to detecting a discrepancy, the second sensor module 110 can execute a calibration cycle, such as by adjusting a predefined or mapped location of the second sensor module 110 (e.g., to correct for sensor placement inaccuracies) in a virtual sensor module 110 map representing locations of the sensor modules 110.

### 16. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. A method comprising:
receiving a first set of signals broadcast within a detection zone of a sensor module;
detecting a first analog video signal, broadcast by an unmanned aerial vehicle, in the first set of signals;
extracting a first sequence of frames, depicting surfaces within a field of view of the unmanned aerial vehicle, from the first analog video signal;
selecting a first frame, in the first sequence of frames, for locating the unmanned aerial vehicle;
serving the first frame and a sensor location of the sensor module to a localization model configured to search a virtual map for aerial vehicle locations and aerial vehicle headings predicted to yield frames captured by unmanned aerial vehicles traversing the detection zone;
receiving a first estimated location and a first estimated heading of the unmanned aerial vehicle, predicted to yield the first frame, from the localization model;
generating an alert comprising the first estimated location and the first estimated heading of the unmanned aerial vehicle; and
serving the alert to a user.

2. The method of claim 1:
wherein receiving the first estimated location and the first estimated heading of the unmanned aerial vehicle comprises receiving the first estimated location and the first estimated heading of the unmanned aerial vehicle at a first time;·
further comprising:
extracting a first set of overlay features from the first frame;
identifying a vehicle type of the unmanned aerial vehicle based on a distribution of text and iconography of the first set of overlay features;
serving a second frame, in the first sequence of frames, depicting surfaces within the field of view of the unmanned aerial vehicle at a second time, succeeding the first time, to the localization model;
receiving a second estimated location and a second estimated heading of the unmanned aerial vehicle at the second time from the localization model;
extrapolating a projected flight zone representing predicted future positions of the unmanned aerial vehicle based on:
the first estimated location;
the second estimated location;
the second estimated heading; and
a set of maneuverability characteristics of the vehicle type; and o in response to presence of a landmark within the projected flight zone, estimating a time of arrival of the unmanned aerial vehicle at the landmark based on a velocity of the unmanned aerial vehicle; and
wherein generating the alert comprises generating the alert further comprising the time of arrival of the unmanned aerial vehicle at the landmark.

3. The method of claim 1:
further comprising:
extracting a first set of coordinates of the unmanned aerial vehicle from the first frame;
retrieving a first reference frame representing surfaces predicted to appear within the field of view of the unmanned aerial vehicle at the first set of coordinates; and
detecting a first difference between the first frame and the first reference frame based on differences between:
wherein generating the alert comprises, in response to the first difference exceeding a threshold difference, generating the alert indicating inconsistency between the first estimated location of the unmanned aerial vehicle and the first set of coordinates in the first frame.

4. The method of claim 1:
further comprising:
extracting a first set of coordinates of the unmanned aerial vehicle from the first frame;
retrieving a first reference frame representing surfaces predicted to appear within the field of view of the unmanned aerial vehicle at the first set of coordinates; and
detecting a first difference between the first frame and the first reference frame based on differences between:
a first set of topographical features depicted in the first frame; and
a second set of reference topographical features depicted in the first reference frame; and·
wherein generating the alert comprises, in response to the first difference exceeding a threshold difference, generating the alert indicating inconsistency between the first estimated location of the unmanned aerial vehicle and the first set of coordinates in the first frame.

5. The method of claim 1:
wherein extracting the first sequence of frames from the first analog video signal comprises extracting the first frame in a first resolution from the first analog wherein selecting the first frame for locating the unmanned aerial vehicle comprises:
o converting the first frame into a first representative image in a second resolution less than the first resolution;
o serving the first representative image to a frame selection model for detection of distinguishable surfaces depicted in the first representative image;
o receiving a first confidence score for localization of the first frame within the virtual map from the frame selection model; and
wherein serving the first frame to the localization model comprises serving the first frame, in the first resolution, to the localization model.

6. The method of claim 1:
further comprising:
identifying a vehicle type of the unmanned aerial vehicle based on a distribution of text and iconography of the first set of overlay features;
extracting a second state of charge of the unmanned aerial vehicle at a second time, succeeding the first time, from a second frame in the first sequence of frames;
deriving a power consumption of the unmanned aerial vehicle between the first time and the second time based on:estimating a payload of the unmanned aerial vehicle based on:
wherein generating the alert comprises generating the alert further comprising the payload of the unmanned aerial vehicle.

7. The method of claim 1:
further comprising:
extracting a first set of optical sensor parameters and a first altitude of the unmanned aerial vehicle from the first frame;
deriving the field of view of the unmanned aerial vehicle based on the first set of optical sensor parameters; and
wherein serving the first frame and the sensor location to the localization model comprises serving the first frame, the sensor location, and a first prompt to search the target region of the virtual map for estimated locations and estimated headings predicted to yield the first frame when occupied by the unmanned aerial vehicle.

8. The method of claim 1:
further comprising:
accessing a description of the sensor location of the sensor module;
defining the detection zone comprising a three-dimensional zone surrounding the sensor location of the sensor module;
segmenting the detection zone into a set of subzones;
for each subzone in the set of subzones, accessing a set of images depicting topographical features of surfaces within the subzone, each image in the set of images labeled with a location, a heading, and an altitude within the subzone;
detecting a set of landmarks located in the detection zone based on topographical features depicted in images of the set of subzones; and
aggregating the set of images into the virtual map of the detection zone, the virtual map annotated with the set of landmarks; and
wherein serving the first frame and the sensor location to the localization model comprises prompting the localization model to:
return the first estimated location and the first estimated heading corresponding to a first image exhibiting a highest correspondence to the first frame.

9. The method of claim 1:
wherein extracting the first sequence of frames from the first analog video signal comprises demodulating the first analog video signal to generate the first sequence of frames, each frame in the first sequence of frames depicting topographical features of surfaces within an oblique perspective of an optical sensor of the unmanned aerial vehicle;
wherein selecting the first frame for locating the unmanned aerial vehicle comprises selecting the first frame in response to presence of distinguishable topographical features in the first frame; and
wherein serving the first frame to the localization model comprises serving the first frame to the localization model configured to search the virtual map comprising a set of images, each image in the set of images:
depicting topographical features of surfaces within an oblique perspective; and
labeled with a location and a heading.

10. The method of claim 1:
further comprising:
defining a nominal sampling frequency, proportional to the sensitivity score, and a nominal sampling window, inversely proportional to the sensitivity score, for sampling frames during a first time period;
wherein extracting the first sequence of frames from the first analog video signal comprises, during the first time period, extracting the first sequence of frames from the first analog video signal at the nominal sampling frequency during the nominal sampling window;
wherein selecting the first frame for locating the unmanned aerial vehicle comprises:
for each frame in the first sequence of frames, calculating a confidence score for localization of the frame within the virtual map based on presence of distinguishable surfaces depicted in the frame; and
in response to expiration of the nominal sampling window and in response to a first confidence score for the first frame exceeding confidence scores for each frame in the first sequence of frames, selecting the first frame; and
further comprising, in response to the first estimated location of the unmanned aerial vehicle falling within a threshold distance of the landmark:
defining a second sampling frequency, greater than the nominal sampling frequency, and a second sampling window, less than the nominal sampling window, for sampling frames during a second time period succeeding the first time period.

11. The method of claim 1:
· wherein receiving the first estimated location of the unmanned aerial vehicle comprises receiving the first estimated location of the unmanned aerial vehicle at a first time;
o receiving an identification signal broadcast by the unmanned aerial vehicle;
o extracting a vehicle type of the unmanned aerial vehicle from the identification signal;
o accessing a maximum velocity of the vehicle type;
o serving a second frame, in the first sequence of frames, depicting surfaces within the field of view of the unmanned aerial vehicle at a second time, succeeding the first time, to the localization model;
o receiving a second estimated location of the unmanned aerial vehicle at the second time from the localization model; and
o deriving a real velocity of the unmanned aerial vehicle based on:
· wherein generating the alert comprises, in response to the real velocity exceeding the maximum velocity of the vehicle type, generating the alert indicating inconsistency between the vehicle type in the identification signal and the real velocity of the unmanned aerial vehicle.

12. The method of claim 1:
further comprising:
during a second time period:
during a first time period succeeding the second time period:
wherein generating the alert comprises, during the first time period, generating the alert in response to presence of the vehicle identifier on the list of unauthorized aerial vehicles.

13. The method of claim 1, further comprising:
detecting a second analog video signal, broadcast by the unmanned aerial vehicle, during a second time period;
extracting a second sequence of frames, depicting surfaces within the field of view of the unmanned aerial vehicle during the second time period, from the second analog video signal;
serving a second set of frames, in the second sequence of frames, and the sensor location to the localization model;
receiving a second set of estimated locations and a second set of estimated headings of the unmanned aerial vehicle during the second time period from the localization model;
the second set of estimated locations; and
the second set of estimated headings;
injecting a second set of points, representing the second estimated trajectory of the unmanned aerial vehicle, into an aerial vehicle map;
characterizing a second flight profile of the unmanned aerial vehicle based on the second estimated trajectory; and
in response to the second flight profile corresponding to a low-risk profile, withholding generation of a second alert.

14. The method of claim 13:
wherein extracting the first sequence of frames from the first analog video signal comprises extracting the first sequence of frames depicting surfaces within the field of view of the unmanned aerial vehicle during a first time period succeeding the second time period;
further comprising:
serving a first set of frames, in the first sequence of frames, and the sensor location to the localization model;
receiving a first set of estimated locations and a first set of estimated headings of the unmanned aerial vehicle, predicted to yield the first set of frames, during the first time period from the localization model;
extrapolating a first estimated trajectory of the unmanned aerial vehicle based on:
injecting a first set of points into the aerial vehicle map, the first set of points representing the first estimated trajectory of the unmanned aerial vehicle; and
characterizing a first flight profile of the unmanned aerial vehicle based on the first estimated trajectory; and
wherein generating the alert comprises generating the alert in response to the first flight profile corresponding to a high-risk profile.

15. A method comprising:
accessing a set of signals broadcast within a detection zone of a sensor module;
detecting an analog video signal, broadcast by an unmanned aerial vehicle, in the set of signals;
extracting a sequence of frames, depicting surfaces within a field of view of the unmanned aerial vehicle, from the analog video signal;
selecting a first frame from the sequence of frames;
deriving a first estimated heading of the unmanned aerial vehicle, predicted to yield the first frame, based on correspondence between:
a first set of topographical features depicted in the first frame; and
a population of topographical features represented in a virtual map of the detection zone;
generating an alert comprising the first estimated heading of the unmanned aerial vehicle; and
serving the alert to a user.

16. The method of claim 15:
for each frame in the sequence of frames:
in response to a first confidence score for the first frame exceeding confidence scores for each frame in the sequence of frames, selecting the first frame for locating the unmanned aerial vehicle; and
wherein deriving the first estimated heading of the unmanned aerial vehicle comprises:
serving the first frame to a localization model configured to search a virtual map for aerial vehicle locations and aerial vehicle headings predicted to yield frames captured by unmanned aerial vehicles traversing the detection zone; and
receiving the first estimated heading of the unmanned aerial vehicle, predicted to yield the first frame, from the localization model.

17. The method of claim 15:
further comprising:
accessing a first set of images depicting topographical features of surfaces within the detection zone;
accessing a second set of images captured by the mapping aerial vehicle during the scan, each image in the second set of images labeled with a location, a heading, and an altitude; and
aggregating the first set of images and the second set of images into the virtual map of the detection zone, the virtual map comprising a virtual representation of a landmark located in the detection zone; and
wherein generating the alert comprises:
in response to detecting the first estimated heading oriented toward the landmark, generating the alert further comprising a description of the landmark located along the first estimated heading.

18. The method of claim 15:
wherein deriving the first estimated heading of the unmanned aerial vehicle comprises deriving the first estimated heading and a first estimated location of the unmanned aerial vehicle at a first time;
further comprising:
deriving a second estimated heading and a second estimated location of the unmanned aerial vehicle at a second time, succeeding the first time, based on a second frame in the sequence of frames; and
extrapolating a projected flight zone representing predicted future positions of the unmanned aerial vehicle based on:
wherein generating the alert comprises generating the alert in response to presence of a landmark, located within the detection zone, within the projected flight zone.

19. The method of claim 15:
further comprising:
selecting a set of frames from the sequence of frames;
deriving a set of estimated locations and a set of estimated headings of the unmanned aerial vehicle based on the set of frames;
extrapolating an estimated trajectory of the unmanned aerial vehicle based on:
estimating a minimum distance between the unmanned aerial vehicle and a landmark located within the detection zone based on the set of estimated locations; and
characterizing a flight profile of the unmanned aerial vehicle based on:
wherein generating the alert comprises generating the alert in response to the flight profile corresponding to a high-risk profile.

20. A system comprising:
a receiver configured to:
a wireless communication module;
a controller configured to:
a battery configured to supply power to the receiver and the controller; and
the remote server configured to:
access the sequence of frames from the wireless communication module;
serve a frame, in the sequence of frames, and a sensor location of the sensor module to a localization model configured to search a virtual map for aerial vehicle locations and aerial vehicle headings predicted to yield frames captured by unmanned aerial vehicles traversing the detection zone;
receive an estimated location and an estimated heading of the unmanned aerial vehicle, predicted to yield the frame, from the localization model;
generate an alert comprising the estimated location and the estimated heading of the unmanned aerial vehicle; and
serve the alert to a user via a user interface.
